(19) United States
(12) Patent Application Publication
(10) Pub. No.: US 2023/0264705 A1
(43) Pub. Date: Aug. 24, 2023

(54) CONTROL APPARATUS, DRIVE SYSTEM FOR MOBILITY DEVICES, AND PROGRAM PRODUCT

(71) Applicant: DENSO CORPORATION, Kariya-city (JP)

(72) Inventors: Hiroki NAKANO, Kariya-city (JP); Kousuke BABA, Kariya-city (JP)

(73) Assignee: DENSO CORPORATION, Kariya-city (JP)

(21) Appl. No.: 18/141,743

(22) Filed: May 1, 2023

Related U.S. Application Data
(63) Continuation of application No. PCT/JP21/38974, filed on Oct. 21, 2021.

(30) Foreign Application Priority Data
Oct. 30, 2020 (JP) 2020-182656
Sep. 30, 2021 (JP) 2021-162049

(51) Int. Cl. B60W 50/10; B62D 15/02

(52) U.S. Cl. CPC B60W 50/10; B62D 15/021; B60W 2510/18; B60W 2510/105

(57) ABSTRACT

A control apparatus is applicable to a drive system that measures a user's manipulated parameter, and drives a driving unit constituting a mobility device in accordance with a driving quantity determined based on the user's manipulated parameter. The user's manipulated parameter includes at least one of a user's manipulated variable and a user's manipulated setting. In the control apparatus, a storage unit stores at least one mobility parameter that enables the driving quantity to be determined based on the user's manipulated parameter. A parameter acquiring unit acquires parameter information inputted by a user. The parameter information includes at least one of (i) a user's selected at least one mobility parameter and (ii) information related to the user's selected at least one mobility parameter. In the control apparatus, an updating unit updates, based on the parameter information, the at least one mobility parameter stored in the storage unit.

### CROSS REFERENCE TO RELATED APPLICATIONS

The present application is a bypass continuation application of currently pending international application No. PCT/JP2021/038974 filed on Oct. 21, 2021 designating the United States of America, the entire disclosure of which is incorporated herein by reference, the internal application being based on and claiming the benefit of priority from both Japanese Patent Application No. 2020-182656 filed on Oct. 30, 2020 and Japanese Patent Application No. 2021-162049 filed on Sep. 30, 2021.

### TECHNICAL FIELD

The present disclosure relates to control apparatuses applicable to a drive system for mobility devices, drive systems for mobility devices, and program products for such control apparatuses.

### BACKGROUND

For example, Japanese Patent Application Publication No. 2019-207620 discloses a technology that aims to improve driver's drivability. The technology disclosed in the patent publication calculates driver's driving characteristics in accordance with traveling data resulting from driver's operations, and offers, to a target driver, a selected one of various types of rental vehicles and/or shared vehicles in accordance with the driving characteristics of the target driver; the selected type vehicle is suitable for a target driver. This makes it possible to select, from various types of rental vehicles and/or shared vehicles, one of these various types of rental vehicles and/or shared vehicles; the selected type vehicle is suitable for a target driver. This therefore improves driver's drivability.

### SUMMARY

A driver's manipulated variable, which is linked to a driving unit, determines a drive parameter related to the driving unit. For example, a driver's accelerator opening of an accelerator, i.e., an accelerator pedal, as a driver's manipulated amount of the accelerator, which is linked to an engine or a motor of the vehicle, determines, as the drive parameter related to the engine or the motor, an output quantity of the engine or the motor.

Similarly, a driver's manipulated setting, which is liked to a driving unit, determines a drive parameter related to the driving unit. For example, a driver's manipulated airflow volume setting for an air-conditioner, which is linked to a blower fan of the air-conditioner, determines, as the drive parameter related to the blower fan, a rotational speed of the blower fan. Moreover, a driver's manipulated temperature setting, which is linked to a heater of an air-conditioner, determines, as the drive parameter related to the heater, driving power for the heater.

At least one vehicle parameter, which is previously defined for a vehicle, enables an output of a corresponding at least one driving unit to be determined based on a corresponding at least one driver's manipulated variable or a corresponding at least one driver's manipulated setting.

The at least one vehicle parameter, which is previously defined for a vehicle, may not match a driver's expected output of the corresponding at least one driving unit. This may result in the drivability of the vehicle decreasing. This issue is not limited to an issue for at least one vehicle parameter previously defined for a vehicle. Specifically, this issue is a common issue for at least one mobility parameter, which is previously defined for at least one mobility device, such as at least one ship or at least one aircraft.

From this viewpoint, the present disclosure aims to provide
(1) Control apparatuses applicable to a drive system for a mobility device, each of which is capable of improving the drivability of the mobility device
(2) Drive systems for a mobility device, each of which is capable of improving the drivability of the mobility device
(3) Program products applicable to a controller of a drive system for a mobility device, each of which is capable of improving the drivability of the mobility device

A first exemplary measure according to the present disclosure provides a control apparatus applicable to a drive system that measures a user's manipulated parameter, and drives, through a driving unit, a mobility device in accordance with a driving quantity determined based on the user's manipulated parameter. The user's manipulated parameter includes at least one of a user's manipulated variable and a user's manipulated setting. The control apparatus includes a storage unit that stores at least one mobility parameter that enables the driving quantity to be determined based on the user's manipulated parameter. The control apparatus includes a parameter acquiring unit configured to acquire parameter information inputted by a user. The parameter information includes at least one of (i) a user's selected at least one mobility parameter and (ii) information related to the user's selected at least one mobility parameter. The control apparatus includes an updating unit configured to update, based on the parameter information, the at least one mobility parameter stored in the storage unit.

At least one mobility parameter, which has been previously fixed to be stored in the storage unit, may decrease the user's drivability of the mobility device if the fixed at least one mobility parameter does not match a user's expected output of a corresponding at least one driving unit.

From this viewpoint, the above configuration of the first exemplary measure enables a user to input the parameter information that includes at least one of (i) a user's selected at least one mobility parameter and (ii) information related to the user's selected at least one mobility parameter. The above configuration of the first exemplary measure updates, based on the user's inputted parameter information, the at least one mobility parameter stored in the storage unit.

The above configuration of the first exemplary measure therefore makes it possible to, even if the at least one mobility parameter stored in the storage unit does not match a user's expected output of a corresponding at least one driving unit, update the previously stored at least one mobility parameter to the user's selected at least one mobility parameter that matches the user's expected output of the corresponding at least one driving unit. This improves the user's drivability of the mobility device.

A second exemplary measure according to the present disclosure provides a control apparatus applicable to a drive system that measures a user's manipulated parameter, and drives, through a driving unit, a mobility device in accordance with a driving quantity determined based on the user's manipulated parameter. The user's manipulated parameter includes at least one of a user's manipulated variable and a user's manipulated setting. The control apparatus includes a storage unit that stores at least one mobility parameter that enables the driving quantity to be determined based on the user's manipulated parameter. The control apparatus includes a determination information acquiring unit configured to acquire determination information.

The determination information includes at least one of
(I) Behavior information representing a behavior of the mobility device while the mobility device is moving
(II) Environmental information representing environments around the mobility device
(III) Operation information on each structural unit that constitutes the mobility device

The control apparatus includes an updating unit configured to update, based on the determination information, the at least one mobility parameter stored in the storage unit.

At least one mobility parameter, which has been previously fixed to be stored in the storage unit, may decrease the user's drivability of the mobility device if the fixed at least one mobility parameter does not match a user's expected output of a corresponding at least one driving unit.

Additionally, it may be difficult for a user to update the at least one mobility parameter stored in the storage unit, because the user does not recognize an updated detail of the at least one mobility parameter, which matches a user's expected output of at least one target driving unit.

From this viewpoint, the above configuration of the second exemplary measure updates the at least one mobility parameter stored in the storage unit in accordance with the determination information including at least one of
(I) Behavior information representing a behavior of the mobility device while the mobility device is moving
(II) Environmental information representing environments around the mobility device
(III) Operation information on each structural unit that constitutes the mobility device

The above configuration of the second exemplary measure therefore makes it possible to update the at least one mobility parameter stored in the storage unit to a new one that is suitable for a user even if the at least one mobility parameter does not match a user's expected output of at least one driving unit, and the user does not recognize at least one new mobility parameter that matches the user's expected output of the at least one target driving unit. This results in an improvement of the user's drivability of the mobility device based on the updated at least one mobility parameter.

### BRIEF DESCRIPTION OF THE DRAWINGS

The foregoing and other objects, features, and advantages of the present disclosure will become more apparent from the following detailed description with reference to the accompanying drawings, in which:

FIG. 1 is a diagram illustrating an overall configuration of a drive system according to the first embodiment;

FIG. 2 is a flowchart illustrating a setting routine according to the first embodiment;

FIG. 3A is a view illustrating a setting image;

FIG. 3B is a view illustrating a parameter setting image;

FIG. 4A is a view illustrating an accelerator setting image;

FIG. 4B is a view illustrating a brake setting image;

FIG. 5A is a view illustrating a first handling setting image;

FIG. 5B is a view illustrating a second handling setting image;

FIGS. 6A and 6B are views that illustrate a first air-conditioning setting image;

FIGS. 7A and 7B are views that illustrate a second air-conditioning setting image;

FIGS. 8A and 8B are views that illustrate a charging setting image;

FIGS. 9A to 9E are a joint timing chart illustrating one example of the setting routine according to the first embodiment;

FIG. 10 is a diagram illustrating an overall configuration of a drive system according to the first modification of the first embodiment;

FIG. 11 is a flowchart illustrating a setting routine according to the second modification of the first embodiment;

FIG. 12 is a flowchart illustrating a setting routine according to the second embodiment;

FIGS. 13A and 13B are timing charts illustrating how an accelerator opening changes over time during acceleration of a vehicle;

FIGS. 14A and 14B are timing charts illustrating how a brake stroke changes over time during deceleration of the vehicle;

FIG. 15 is a flowchart illustrating a setting routine according to the third embodiment;

FIG. 16A is an energy efficiency setting image;

FIG. 16B is a graph illustrating a relationship between values of an energy efficiency and corresponding values of an input parameter;

FIG. 17 is a flowchart illustrating a setting routine according to the fourth embodiment;

FIG. 18A is a graph illustrating a relationship between a fitting count number and test constants;

FIG. 18B is a view illustrating a feedback image;

FIG. 19 is a flowchart illustrating a setting routine according to the fifth embodiment;

FIG. 20 is a view illustrating an ID linkage image; and

FIG. 21 is a diagram illustrating variable combinations of components that constitute an input unit, an updating unit, and a storage unit.

### EMBODIMENTS

### First Embodiment

The following describes the first embodiment that shows a drive system 100, which includes a control apparatus according to the present disclosure applied thereto, of each motor vehicle MV as a mobility device with accompanying drawings. Each motor vehicle MV will be referred to simply as each vehicle MV. The drive system 100 of each vehicle MV includes a vehicular device 10 and a server apparatus 80.

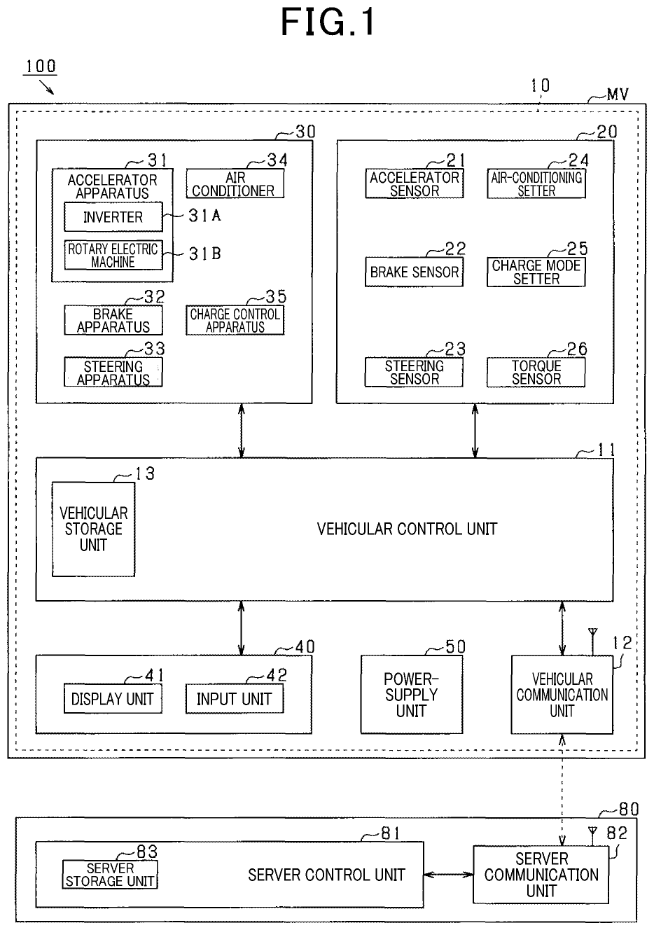

The following describes the vehicular device 10 with reference to FIG. 1.

The vehicular device 10 is installed in each vehicle MV. Private vehicles, company vehicles owned by companies and drivable alternately by their workers, or rental/shared vehicles drivable alternately by drivers, can be used as the vehicles MV.

The vehicular device 10 includes a sensor unit 20, a driving unit 30, a user interface 40, and a power-supply unit 50. The power-supply unit 50 is comprised of a rechargeable battery, and is electrically connected to the sensor unit 20, driving unit 30, and the user interface 40. Electrical power supplied from the power-supply unit 50 drives the sensor unit 20, driving unit 30, and user interface 40. The power-supply unit 50 includes a high-voltage battery and a low-voltage battery. The high-voltage battery performs electrical-power transfer with respect to electric devices that constitute a high-voltage system of the vehicle V. The low-voltage battery performs electrical-power transfer with respect to electric devices that constitute a low-voltage system of the vehicle V. The high-voltage battery can be comprised of, for example, a lithium-ion battery, a nickel-hydrogen battery, or a nickel-metal-hydride battery, and the low-voltage battery can be comprised of, for example, a lead storage battery. The power-supply unit 50 can be chargeable by an external battery charger.

The sensor unit 20 is configured to measure driver's manipulated variables and driver's manipulated settings during driver's operations of the vehicle V. Specifically, the sensor unit 20 includes an accelerator sensor 21, a brake sensor 22, a steering sensor 23, an air-conditioning setter 24, a charge mode setter 25, and a torque sensor 26.

The accelerator sensor 21 is configured to measure, as an accelerator opening, a driver's operated amount of an accelerator member, such as an accelerator pedal.

The brake sensor 22 is configured to measure, as a brake stroke, a driver's operated stroke of a brake member, such as a brake pedal.

The steering sensor 23 is mounted to an electric power steering apparatus 33, and configured to measure a driver's steering angle of a steering wheel of the vehicle V.

The torque sensor 26 is configured to measure driver's steering torque of the steering wheel of the vehicle V. The driver's steering angle and the driver's steering torque will be referred to as driver's steering parameters.

When manipulated by a driver of the vehicle V, the air-conditioning setter 24 is configured to measure a driver's manipulated setting of the air volume of an air-conditioner 34, and a driver's manipulated setting of the temperature of the air conditioner 34.

When manipulated by a driver of the vehicle V, the charge mode setter 25 is configured to measure a driver's manipulated setting of a selected one of plural charge modes, which include a fast-charging mode and a normal-charging mode.

The first embodiment uses, as manipulated parameters, the accelerator opening, the brake stroke, the driver's steering parameters, the driver's manipulated setting of the air volume of the air conditioner 34, the driver's manipulated setting of the temperature of the air conditioner 34, and the driver's manipulated setting indicative of the selected charge mode.

The driving unit 30 is configured to determine drive parameters based on the driver's manipulated variables and driver's manipulated settings measured by the sensor unit 20, and drive the vehicle MV in accordance with the determined drive parameters.

Specifically, the driving unit 30 includes an accelerator apparatus 31, a brake apparatus 32, the electric power steering apparatus 33, an air conditioner 34, and a charge control apparatus 35.

The accelerator apparatus 31 is configured to generate driving torque based on the accelerator opening measured by the accelerator sensor 21 to accordingly apply the generated driving torque to driving wheels of the vehicle MV. Specifically, the accelerator apparatus 31 includes an inverter 31A and a rotary electric machine 31B. The inverter 31A is configured to convert a direct-current (DC) voltage outputted from the power-supply unit 50 into an alternating-current (AC) voltage. The rotary electric machine 31B is configured to generate the driving torque based on the AC voltage outputted from the inverter 31A to accordingly supply the driving torque to the driving wheels of the vehicle MV.

The brake apparatus 32 is configured to generate, as a function of the brake stroke measured by the brake sensor 22, braking torque for the vehicle MV to accordingly apply the braking torque to the driving wheels of the vehicle MV.

The electric power steering apparatus 33 is configured to generate assist torque as a function of the driver's steering angle measured by the steering sensor 23 and the driver's steering torque measured by the torque sensor 26. The assist torque represents torque for controlling an angle, such as a tire angle, of each wheel of the vehicle MV to be steered.

The air-conditioning apparatus 34 includes a blower fan as a blower, and a heater. The blower fan is configured to be driven at a rotational speed that is determined based on the driver's manipulated airflow volume setting set by the air-conditioning setter 24. The heater is configured to be driven by driving power that is determined based on the driver's manipulated temperature setting set by the air-conditioning setter 24.

The charge control apparatus 35 is configured to determine a charging voltage and a charging current based on the driver's manipulated setting of the selected one of the plural charge modes selected by the air-conditioning setter 24, and control charging of the power-supply unit 50 based on the determined charging voltage and the determined charging current.

The user interface 40 includes a display unit 41 and an input unit 42. For example, a vehicle navigation system installed in each vehicle MV serves as the user interface 40 of the vehicle MV. Specifically, the vehicle navigation system includes a touch-panel display that serves as the display unit 41, and the input unit 42 is comprised of various icons displayed on the touch-panel display of the display unit 41.

Specifically, the user interface 40 is configured to display various information items on the display unit 41, and acquires user's responses to the various information items through the input unit 42.

The vehicular device 10 includes a vehicular control unit 11, a vehicular communication unit 12, and a vehicular storage unit 13. The vehicular communication unit 12 has a first function of transmitting, via a communication network, such as the internet, information items generated by the vehicular control unit 11 to the server apparatus 80, and a second function of receiving, via the communication network, information items transmitted from the server apparatus 80.

The vehicular storage unit 13 is comprised of, for example, one or more memories installed in the vehicular control unit 11. The one or more memories are one or more non-transitory tangible storage media except for ROMs, for example, one or more non-volatile memories except for ROMs.

The vehicular control unit 11 is comprised of, for example, at least one microcomputer essentially including a CPU, a ROM, a RAM, and/or a flash memory.

The vehicular control unit 11 is configured to refer to computer programs and various data items stored in the vehicular storage unit 13 to accordingly perform various control tasks. For example, OTA (over-to-air) technology can be used to update the computer programs stored in the vehicular storage unit 13.

Specifically, the vehicular control unit 11 is configured to acquire the driver's manipulated variables and driver's manipulated settings measured by the sensor unit 20, and control the driving unit 30 based on (i) the acquired driver's manipulated variables and driver's manipulated settings, and (ii) vehicle parameters, i.e., vehicle-constant information items. More specifically, the vehicular control unit 11 is configured to, for example, determine an instruction to be transmitted to the inverter 31A. The instruction controls on/off switching operations of switches of the inverter 31A to accordingly increase the driving torque of the rotary electric machine 31B with an increase in the accelerator opening.

Each of the vehicle parameters, i.e., vehicle-constant information items, enables a driving quantity of a corresponding one driving component of the driving unit 30 to be determined based on a corresponding at least one of the driver's manipulated variables and driver's manipulated settings. The vehicle parameters are previously stored in the vehicular storage unit 13.

The vehicle parameters for example include an accelerator parameter TA, a brake parameter TB, first and second handling parameters TC, first and second air-conditioning parameters TD and TE, and a charging parameter TF.

The accelerator parameter TA enables determination of the driving torque of the vehicle MV based on the accelerator opening.

The brake parameter TB enables determination of the braking torque based on the brake stroke.

The first handling parameter TC enables determination of the assist torque based on the steering angle, and the second handling parameter TC enables determination of the assist torque based on the steering torque.

The first air-conditioning parameter TD enables determination of the rotational speed of the blower fan of the air-conditioning apparatus 34 based on the driver's manipulated setting of the air volume outputted from the blower fan.

The second air-conditioning parameter TE enables determination of an electric current value for energization of the heater of the air-conditioning apparatus 34 based on the driver's manipulated setting of the temperature of the heater.

The charging parameter TF enables determination of the charging current and charging voltage as charging variables based on the driver's manipulated setting of the charging mode.

Additionally, the vehicle parameters for example may include a parameter used to determine the operational speed of one or more wipers mounted to, for example, a windshield of the vehicle MV.

The vehicle parameters for example may include a parameter used to determine a balance between the air volume and the temperature for each seat in the vehicle MV. The balance between the air volume and the temperature of the air-conditioning apparatus 34 can be determined based on a combination of the first and second air-conditioning parameters TD and TE.

The vehicle parameters according to the first embodiment serve as mobility parameters. The vehicular storage unit 13 according to the first embodiment serves as a storage unit, and the vehicular control unit 11 according to the first embodiment serves as a control apparatus.

The server apparatus 80, which is located outside each vehicle MV in which the vehicular device 10 is installed, includes a server control unit 81, a server communication unit 82, and a server storage unit 83. The server communication unit 82 has a first function of transmitting, via the communication network, information items generated by the server control unit 81 to the vehicular devices 10, and a second function of receiving, via the communication network, information items transmitted from each vehicular device 10.

The server control unit 81 is comprised of, for example, at least one microcomputer essentially including a CPU, a ROM, a RAM, and/or a flash memory.

The server storage unit 83 is comprised of, for example, one or more memories. The server storage unit 83 is configured to store legal regulation data. The legal regulation data is used to determine an upper limit and a lower limit of each of the vehicle parameters in compliance with the laws and regulations on emission control. The server storage unit 83 according to the first embodiment serves as an external storage unit, and the legal regulation data according to the first embodiment serves as upper-lower limit determination information.

The user interface 40 of each vehicular device 10 according to the first embodiment enables a driver to input, to the corresponding vehicular device 10, updated parameters. Each vehicle MV according to the first embodiment is configured to select, as its driving mode, one of predetermined plural driving modes that include, for example, a normal mode, a sport mode, and an ecological mode. For example, when the accelerator opening is kept constant, the ecological mode enables a value of the driving torque to be lower than a value of the driving torque for the normal mode. In addition, when the accelerator opening is kept constant, the sport mode enables a value of the driving torque to be higher than a value of the driving torque for the normal mode.

That is, the ecological mode, the normal mode, and the sport mode have respectively different values of the driving torque when the accelerator opening is set to any constant value. Values of each of the vehicle parameters are different from one another for the respective normal, sport, and ecological modes.

Each vehicular device 10 according to the first embodiment enables a driver to input, to the corresponding vehicular device 10, driver's selected vehicle parameters, that is, driver's updated vehicle parameters, for each of the driving modes, making it possible for a driver to set, in detail, updated vehicle parameters.

The vehicular control unit 11 is configured to display, on the display unit 41, an input range for each vehicle parameter. The displayed input range for each vehicle parameter is restricted between the upper and lower limits of the corresponding vehicle parameter. This enables a driver to freely set one or more new vehicle parameters as long as each of the new vehicle parameters is within the input range determined for the corresponding one of the new vehicle parameters. Specifically, a driver can enter updated vehicle parameters through the input unit 42.

The following describes a setting routine carried out by the vehicular control unit 11 and the server control unit 81; the setting routine enables a driver to input updated vehicle parameters to the vehicular control unit 11.

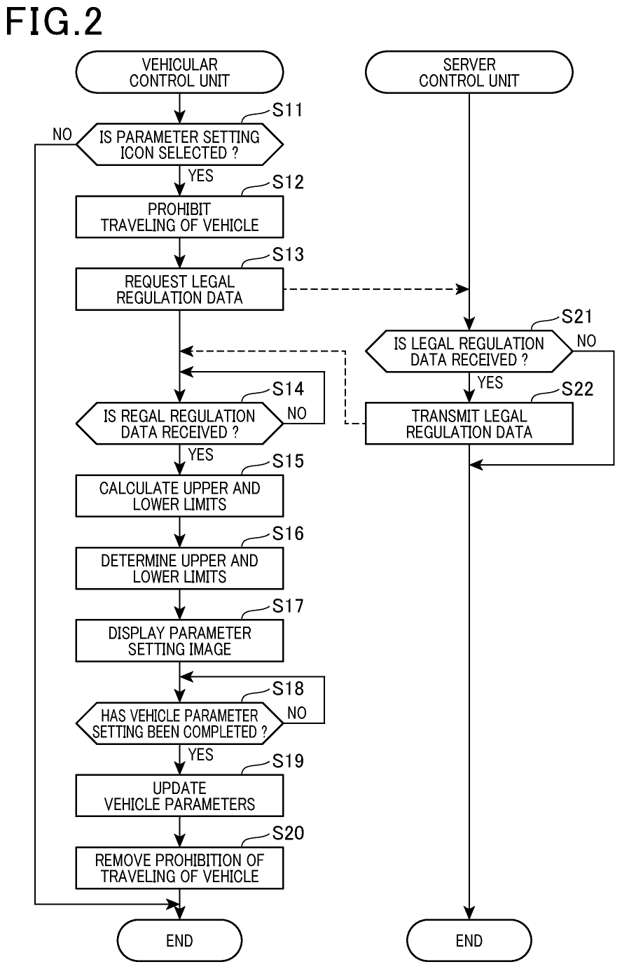

FIG. 2 illustrates a flowchart of the setting routine according to the first embodiment. The vehicular control unit 11 and the server control unit 81 are programmed to carry out, every control period, the setting routine each time a start switch, such as a power switch, is turned on by a driver to instruct the vehicular control unit 11 to start up.

First, the following describes the first part of the setting routine carried out by the vehicular control unit 11.

When starting the setting routine, the vehicular control unit 11 determines whether a vehicle-parameter setting request is inputted thereto through the input unit 42 in step S11.

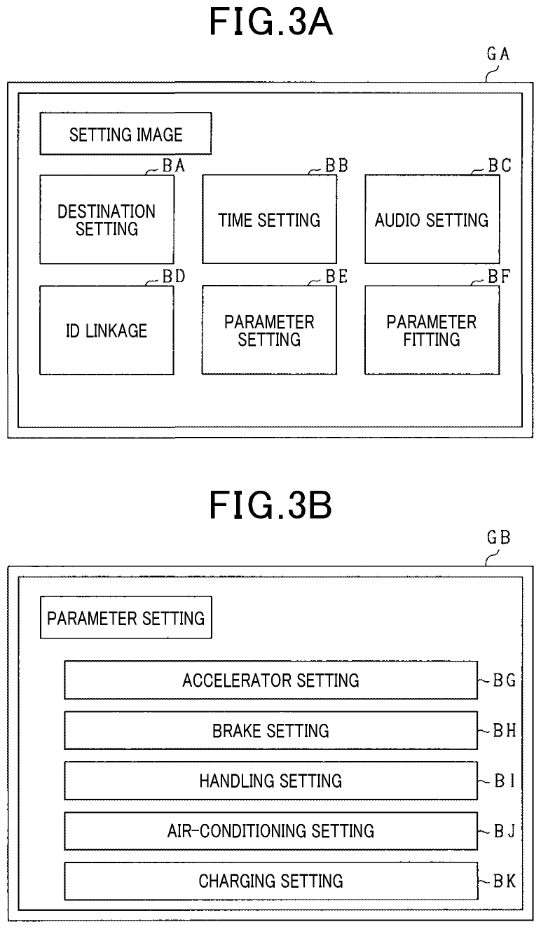

FIG. 3A illustrates, as an example, a setting image GA displayed on the display unit 41 when the user interface 40 serves as the vehicle navigation system. Specifically, the setting image GA includes a destination setting icon BA, a time setting icon BB, an audio setting icon BC, an ID linkage icon BD, a parameter setting icon BE, and a parameter fitting icon BF.

When determining that the setting image GA is displayed on the display unit 41 in response to a driver's input operation while the vehicle MV is stopped, and the parameter setting icon BE is selected by a driver through the input unit 42, the vehicular control unit 11 determines that the vehicle-parameter setting request is inputted thereto through the input unit 42 (YES in step S11). Then, the setting routine proceeds to step S12. Otherwise, when determining that the parameter setting icon BE has not been selected by a driver through the input unit 42, the vehicular control unit 11 determines that the vehicle-parameter setting request is not inputted thereto through the input unit 42 (NO in step S11), terminating the setting routine. The ID linkage icon BD and the parameter fitting icon BF will be described later.

In step S12, the vehicular control unit 11 performs a prohibition task of prohibiting traveling of the vehicle MV. For example, the vehicular control unit 11 prohibits switching control of the inverter 31A to thereby prevent an AC voltage from being supplied to the rotational electric machine 31B even if a driver mistakenly operates the accelerator pedal.

Next, the vehicular control unit 11 transmits, to the server apparatus 80, a request for sending, thereto, the legal regulation data through the vehicular communication unit 12 in step S13; the request will also be referred to as a legal regulation data request. Then, the vehicular control unit 11 serves as a communication unit to perform a determination task (see step S14) of waiting until receiving the legal regulation data from the server apparatus 80 (NO in step S14).

Upon receiving the legal regulation data from the server apparatus 80, the determination task in step S14 is YES. Then, the vehicular control unit 11 calculates the upper and lower limits for each of the vehicle parameters in accordance with (i) the legal regulation data received in step S14, and (ii) output limits previously determined for the driving unit 30 in step S15.

Following the operation in step S15, the vehicular control unit 11 serves as an upper and lower limit determiner to determine the calculated upper and lower limits for each of the vehicle parameters as upper and lower limits for the corresponding one of the vehicle parameters in step S16. Then, the setting routine proceeds to step S17.

In step S17, the vehicular control unit 11 serves as a permission unit that permits a driver to input updated vehicle parameters, and thereafter, the setting routine proceeds to step S18. Specifically, in step S17, the vehicular control unit 11 displays a parameter setting image GB on the display unit 41.

FIG. 3B illustrates, as an example, the parameter setting image GB displayed on the display unit 41. Specifically, the parameter setting image GB includes
(1) An accelerator setting icon BG for setting the accelerator parameter TA
(2) A brake setting icon BH for setting the brake parameter TB
(3) A handling setting icon BI for setting the first and second handling parameters TC
(4) An air-conditioning setting icon BJ for setting the first and second air-conditioning parameters TD and TE
(5) A charging setting icon BK for setting the charging parameter TF

A driver's selection of any of the setting icons BG, BH, BI, BJ, and BK causes a setting image linked to the selected one of the setting icons BG, BH, BI, BJ, and BK to be selectably displayed on the display unit 41. The selected image enables a driver to input thereon a corresponding vehicle parameter.

Specifically, a driver's selection of the accelerator setting icon BG causes an accelerator setting image GC linked to the selected accelerator setting icon BG to be selectably displayed on the display unit 41. This enables an input of an updated accelerator parameter TA.

A driver's selection of the brake setting icon BH causes a brake setting image GD linked to the selected brake setting icon BH to be selectably displayed on the display unit 41. This enables an input of an updated brake parameter TB.

A driver's selection of the handling setting icon BI causes handling setting images GI linked to the selected handling setting icon BI to be selectably displayed on the display unit 41. This enables an input of updated first and second handling parameters TC.

A driver's selection of the air-conditioning setting icon BJ causes air-conditioning setting images GJ linked to the selected air-conditioning setting icon BJ to be selectably displayed on the display unit 41. This enables an input of updated first and second air-conditioning parameters TD and TE.

A driver's selection of the charging setting icon BK causes a charging setting image GK linked to the selected charging setting icon BK to be selectably displayed on the display unit 41. This enables an input of an updated charging parameter TF.

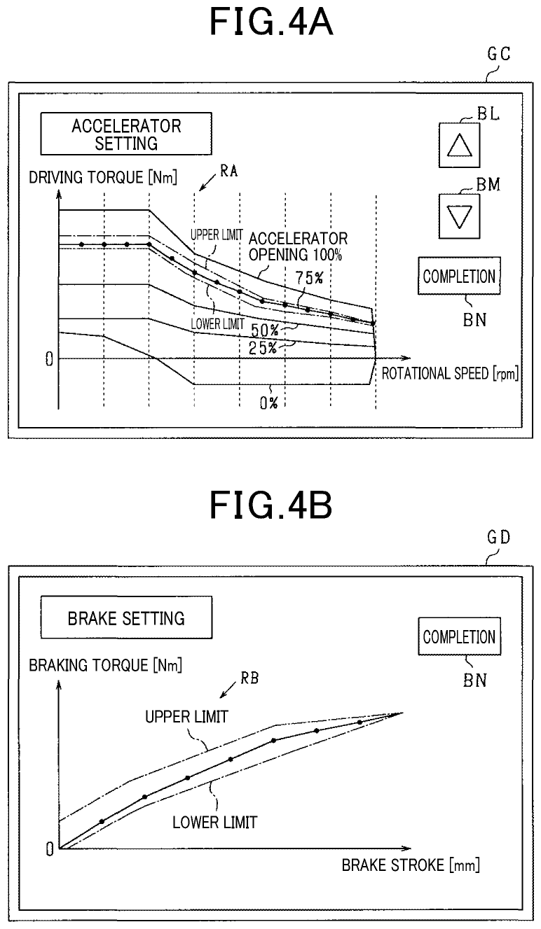

FIG. 4A illustrates the accelerator setting image GC.

The accelerator setting image GC includes a graph RA. The graph RA shows a relationship between, for each sampled value of the accelerator opening, values of the rotational speed of the rotary electric machine 31B and corresponding values of the driving torque of the rotary electric machine 31B. The accelerator setting image GC also includes an upward icon BL, a downward icon BM, and a completion icon BN.

A driver's click of the upward icon BL and/or downward icon BM enable selection of any one of the sampled values of the accelerator opening. FIG. 4A illustrates that 75% of the accelerator opening is selected. When one of the sampled values of the accelerator opening, such as 75%, is selected, the present accelerator parameter TA is plotted in the graph RA; the accelerator parameter TA is configured such that values of the rotational speed of the rotary electric machine 31B at the selected sampled value of the accelerator opening respectively correlate with corresponding values of the driving torque of the rotary electric machine 31B at the selected sampled value of the accelerator opening.

Additionally, an upper limit curve and a lower limit curve of the driving torque for the accelerator parameter TA are also plotted in the graph RA. This enables a driver to set, for each value of the rotational speed of the rotary electric machine 31B, a corresponding value of the driving torque of the rotary electric machine 31B within a range partitioned between the upper and lower limit curves.

Specifically, a driver can set an updated accelerator parameter TA for each sampled value of the accelerator opening. After termination of setting the updated accelerator parameter TA, a driver's click of the completion icon BN is selected.

FIG. 4B illustrates the brake setting image GD.

The brake setting image GD includes a graph RB. The graph RB shows a relationship between quantities of the brake stroke and corresponding values of the braking torque for braking the vehicle MV. The brake setting image GD also includes a completion icon BN.

In the graph RB, the present brake parameter TB is plotted; the brake parameter TB is configured such that quantities of the brake stroke respectively correlate with corresponding values of the braking torque for braking the vehicle MV.

Additionally, an upper limit curve and a lower limit curve of the braking torque for the brake parameter TB are also plotted in the graph RB. This enables a driver to set any value of the braking torque within a range partitioned between the upper and lower limit curves.

Specifically, a driver can set an updated brake parameter TB. After termination of setting the updated brake parameter TB, the driver's click of the completion icon BN is selected.

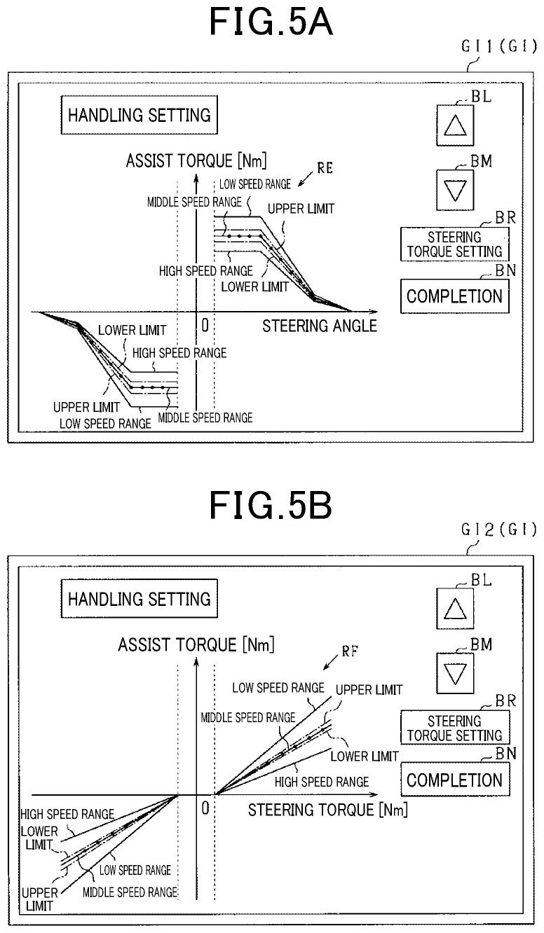

FIGS. 5A and 5B illustrate the handling setting images GI.

The handling setting images GI include a first handling setting image GI1 and a second handling setting image GI2.

The first handling setting image GI1 includes a graph RE. The graph RE illustrates the first handling parameter TC that shows a relationship between, for each sampled value of the vehicle speed, values of the steering angle and corresponding values of the assist torque.

The second handling setting image GI2 includes a graph RF. The graph RF illustrates the second handling parameter TC that shows a relationship between, for each sampled range of the vehicle speed, values of the steering torque and corresponding values of the assist torque.

FIG. 5A illustrates the first handling setting image GI1. The first handling setting image GI1 includes, in addition to the graph RE, the upward icon BL, the downward icon BM, a switching icon BR, and the completion icon BN. Similarly, FIG. 5B illustrates the second handling setting image GI2. The second handling setting image GI2 includes, in addition to the graph RF, the upward icon BL, the downward icon BM, the switching icon BR, and the completion icon BN.

A driver's click of the switching icon BR in the first handling setting image GI1 enables the first handling setting image GI1 to be switched to the second handling setting image GI2, and a driver's click of the switching icon BR in the second handling setting image GI2 enables the second handling setting image GI2 to be switched to the first handling setting image GI1.

The graph RE illustrated in FIG. 5A shows that, the higher the vehicle speed, the smaller the assist torque. When the steering angle is within a predetermined range including zero, the assist torque is kept zero in a dead zone. FIG. 5A illustrates an example that
(I) The assist torque is kept constant when the absolute value of the steering angle is smaller than or equal to a predetermined angle
(II) The larger the absolute value of the steering angle, the smaller the assist torque, when the absolute value of the steering angle is larger than the predetermined angle

The graph RF illustrated in FIG. 5B shows that, the higher the vehicle speed, the smaller the assist torque. When the steering torque is within a predetermined range including zero, the assist torque is kept zero in a dead zone. FIG. 5B illustrates an example that, the larger the absolute value of the steering torque, the larger the assist torque.

A driver's click of the upward icon BL and/or downward icon BM in each of the first and second handling setting images GI1 and GI2 enables selection of any one of the sampled ranges of the vehicle speed. Each of FIGS. 5A and 5B illustrates that any one of three ranges of the vehicle speed, such as a predetermined low range, a predetermined middle range, and a predetermined high range, can be selected. In each of FIGS. 5A and 5B, the predetermined middle range of the vehicle speed is selected. Any one of two ranges or four or more ranges of the vehicle speed can be selected.

When one of the sampled ranges of the vehicle speed is selected, the present first handling parameter TC is plotted in the graph RE; the first handling parameter TC is configured such that values of the steering angle at the selected sampled range of the vehicle speed respectively correlate with corresponding values of the assist torque at the selected sampled range of the vehicle speed.

Similarly, when one of the sampled ranges of the vehicle speed is selected, the present second handling parameterTC is plotted in the graph RF; the second handling parameter TC is configured such that values of the steering torque at the selected sampled range of the vehicle speed respectively correlate with corresponding values of the assist torque at the selected sampled range of the vehicle speed.

Additionally, an upper limit curve and a lower limit curve of the assist torque for each of the first and second handling parameters TC are also plotted in the corresponding one of the graphs RE and RE. This enables a driver to set, for each value of the steering angle, a corresponding value of the assist torque within a range partitioned between the upper and lower limit curves. Similarly, this enables a driver to set, for each value of the steering torque, a corresponding value of the assist torque within the range partitioned between the upper and lower limit curves.

When a driver wants to make the assist torque higher with respect to his/her steering of the steering wheel in order to have a lighter operation feeling of the steering, the driver can set, for each value of the steering angle, a corresponding value of the assist torque in the graph RE illustrated in FIG. 5A to be closer to the upper limit curve than a middle curve between the upper and lower limit curves is. Otherwise, when a driver wants to make the assist torque lower with respect to his/her steering of the steering wheel in order to have a heavier operation feeling of the steering, the driver can set, for each value of the steering angle, a corresponding value of the assist torque in the graph RE illustrated in FIG. 5A to be closer to the lower limit curve than the middle curve between the upper and lower limit curves is.

The more rapidly a driver's steering operation of the steering wheel, the higher the rate of change of the steering angle. The higher the rate of change of the steering angle, the larger the steering torque, resulting in the assist torque being larger.

In contrast, the more slowly a driver's steering operation of the steering wheel, the lower the rate of change of the steering angle. The lower the rate of change of the steering angle, the smaller the steering torque, resulting in the assist torque being smaller.

For the above reasons, in order to have a lighter operation feeling of the steering, a driver can set, for each value of the steering torque, a corresponding value of the assist torque in the graph RF illustrated in FIG. 5B, to be closer to the upper limit curve than a middle curve between the upper and lower limit curves is. Otherwise, in order to have a heavier operation feeling of the steering, a driver can set, for each value of the steering torque, a corresponding value of the assist torque in the graph RF illustrated in FIG. 5B to be closer to the lower limit curve than the middle curve between the upper and lower limit curves is.

After termination of setting new first and second handling parameters TC, a driver's click of the completion icon BN is selected.

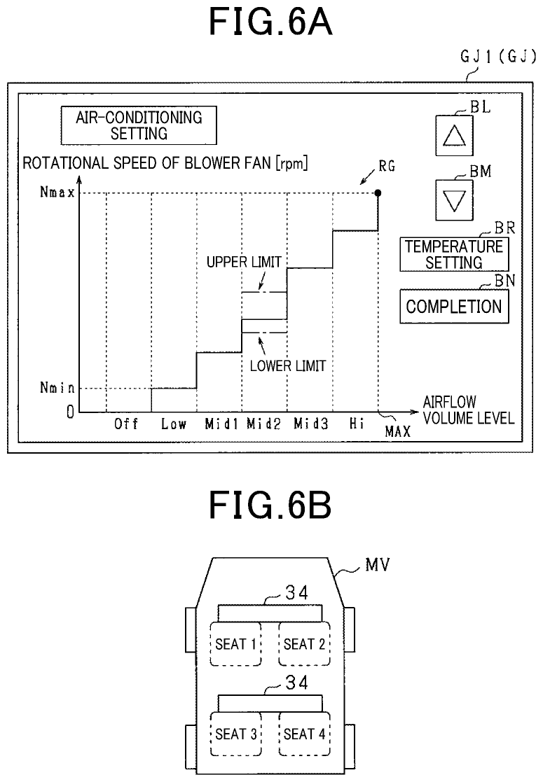

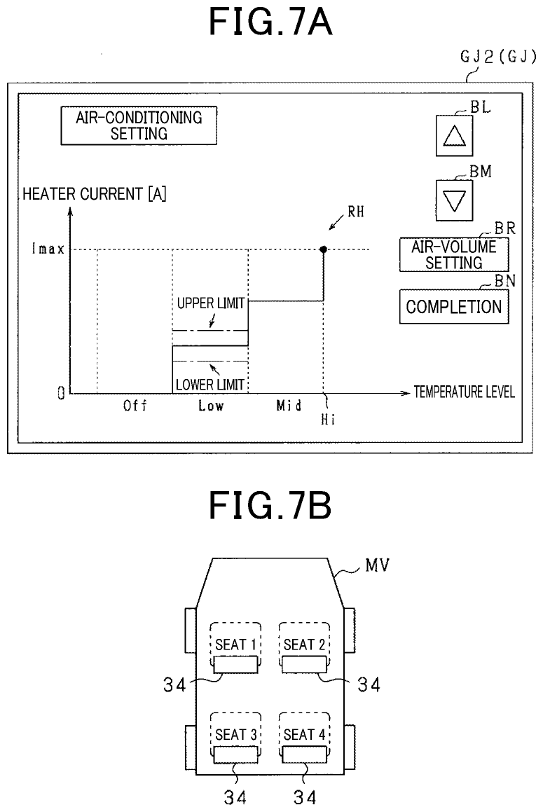

FIGS. 6A and 7A illustrate the air-conditioning setting images GJ.

The air-conditioning setting images GJ include a first air-conditioning setting image GJ1 and a second air-conditioning setting image GJ2.

The first air-conditioning setting image GJ1 includes a graph RG. The graph RG illustrates the first air-conditioning parameter TD that shows a relationship between airflow volume levels of the air-conditioning apparatus 34 and corresponding rotational-speed settings for the blower fan.

The second air-conditioning setting image GJ2 includes a graph RH. The graph RH illustrates the second air-conditioning parameter TE that shows a relationship between temperature levels of the air-conditioning apparatus 34 and corresponding current settings for the heater.

FIG. 6A illustrates the first air-conditioning setting image GJ1. The first air-conditioning setting image GJ1 includes, in addition to the graph RG, the upward icon BL, the downward icon BM, the switching icon BR, and the completion icon BN. Similarly, FIG. 7A illustrates the second air-conditioning setting image GJ2. The second air-conditioning setting image GJ2 includes, in addition to the graph RH, the upward icon BL, the downward icon BM, the switching icon BR, and the completion icon BN.

A driver's click of the switching icon BR in the first air-conditioning setting image GJ1 enables the first air-conditioning setting image GJ1 to be switched to the second air-conditioning setting image GJ2, and a driver's click of the switching icon BR in the second air-conditioning setting image GJ2 enables the second air-conditioning setting image GJ2 to be switched to the first air-conditioning setting image GJ1.

The airflow volume levels are, as illustrated in FIG. 6A, previously determined to increase stepwise in the order from a first level “Off”, a second level “Low”, a third level “Mid1”, a fourth level “Mid2”, a fifth level “Mid3”, a seventh level “Hi”, and an eighth level “MAX”. When the air volume of the air-conditioning apparatus 34 is set to the first level “Off”, the rotational speed of the blower fan becomes zero, causing no air to be blown out from a vent of the air-conditioning apparatus 34 located inside the vehicle MV. FIG. 6A illustrates an example that, when the air volume of the air-conditioning apparatus 34 is set to the second level “Low”, the rotational speed of the blower fan becomes a minimum speed Nmin, and, when the air volume of the air-conditioning apparatus 34 is set to the eighth level “MAX”, the rotational speed of the blower fan becomes a maximum speed Nmax.

A driver's click of the upward icon BL and/or the downward icon BM in the first air-conditioning setting image GJ1 enables selection of any one of the airflow volume levels. In FIG. 6A, the fourth level “Mid2” is selected. When the air volume of the air-conditioning apparatus 34 is set to the eighth level “MAX”, the rotational speed of the blower fan cannot be adjusted, because the rotational speed of the blower fan is fixed to the maximum speed Nmax at the air volume of the air-conditioning apparatus 34 being set to the eighth level “MAX”.

When one of the airflow volume levels is selected, the present first air-conditioning parameter TD is plotted in the graph RG; the first air-conditioning parameter TD is configured such that the selected airflow volume level of the air-conditioning apparatus 34 correlates with a corresponding rotational-speed setting for the blower fan.

An upper limit and a lower limit of the rotational speed of the blower fan are plotted in the graph RG. This enables a driver to set, for each airflow volume level, a corresponding value of the rotational speed of the blower fan within a range partitioned between the upper and lower limits.

That is, a driver can set an updated first air-conditioning parameter TD for each airflow volume level. For example, when a driver wants to make the temperature inside the vehicle MV lower, the driver can set, for each airflow volume level, a corresponding value of the rotational speed of the blower fan in the graph RG illustrated in FIG. 6A to be closer to the upper limit than a middle value between the upper and lower limits is.

After termination of setting the updated first air-conditioning parameter TD, a driver's click of the completion icon BN is selected.

If, as illustrated in FIG. 6B, the separate bower fans, i.e., the separate air-conditioning apparatuses 34, are respectively provided for the first set a driver's seat 1 and a front passenger seat 2 and the second set of backseats 3 and 4, the first air-conditioning parameter TD can be set individually for each of the separate bower fans, i.e., the separate air-conditioning apparatuses 34.

The graph RH illustrated in FIG. 7A illustrates the second air-conditioning parameter TE that shows a relationship between temperature levels of the air-conditioning apparatus 34 and corresponding current settings for the heater. The temperature levels of the heater are, as illustrated in FIG. 7A, previously determined to increase stepwise in the order from a first level “Off”, a second level “Low”, a third level “Mid”, and a fourth level “Hi”. When the temperature level of the heater is set to the first level “Off”, the value of the electric current for energization of the heater becomes zero. When the temperature level of the heater is set to the fourth level “Hi”, the value of the electric current for energization of the heater becomes a maximum value Imax.

A driver's click of the upward icon BL and/or the downward icon BM in the second air-conditioning setting image GJ2 enables selection of any one of the temperature levels. In FIG. 7A, the second level “low” is selected. When the temperature level is set to the fourth level “Hi”, the electric current for energization of the heater cannot be adjusted, because the electric current for energization of the heater is fixed to the maximum current value Imax at the temperature level being set to the fourth level “Hi”.

When one of the temperature levels is selected, the present second air-conditioning parameter TE is plotted in the graph RH; the second air-conditioning parameter TE is configured such that the selected temperature level correlates with a corresponding value of the electric current for the heater.

An upper limit and a lower limit of the electric current for energization of the heater are plotted in the graph RH. This enables a driver to set, for each temperature level, a corresponding value of the electric current for energization of the heater within a range partitioned between the upper and lower limits.

That is, a driver can set an updated second air-conditioning parameter TE for each temperature level. For example, when a driver wants to make the temperature inside the vehicle MV higher, the driver can set, for each temperature level, a corresponding value of the electric current for energization of the heater in the graph RH illustrated in FIG. 7A to be closer to the upper limit than a middle value between the upper and lower limits is. After termination of setting the updated second air-conditioning parameter TE, a driver's click of the completion icon BN is selected.

If the air conditioning apparatus 34 is designed as a hot-air blowing air-conditioning apparatus, a thermal source of the air conditioning apparatus 34 can be used as the heater. In this modification, as illustrated in FIG. 7B, a seat heater provided for each of the seats 1 to 4 can be used as the heater of the air conditioning apparatus 34.

Specifically, in this modification, the second air-conditioning parameter TE can be set individually for each of the seat heaters.

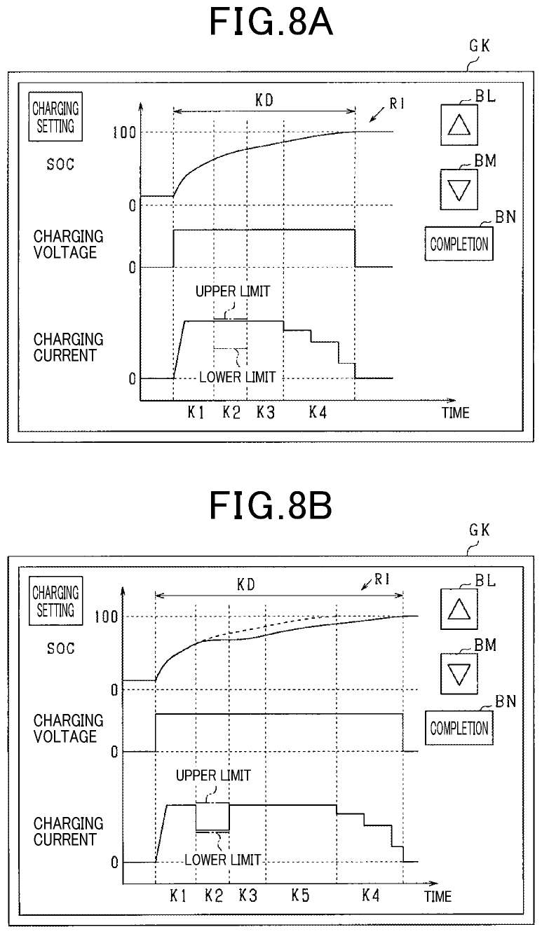

FIG. 8A illustrates the charging setting image GK. The charging setting image GK includes a graph RI. The graph RI illustrates, while the power-supply unit 50 has been fully charged for a charging period KD by a constant voltage, a joint timing chart illustrating
(I) How the state of charge (SOC) changes over time
(II) How the charging voltage changes over time
(III) How the charging current changes over time

The charging setting image GK includes, in addition to the graph RI, the upward icon BL, the downward icon BM, and the completion icon BN.

The graph RI shows, for each of time-series period segments K1 to K4 in the charging period KD of the power-supply unit 50, a corresponding manipulated setting of the charging current as the present charging parameter. Dividing the charging period KD enables the time-series period segments K1 to K4 to be generated. The number of division of the charging period KD and/or the timing of dividing the charging period KD can be freely determined by a user. FIG. 8A illustrates an example that the charging period KD is divided into the four time-series period segments K1 to K4, and, in FIG. 8A, the period segment K2 is selected.

When one of the time-series period segments K1 to K4 is selected, the present charging parameter TF for the selected time-series period segment, i.e., the present driver's manipulated setting of the charging current, in the selected period segment K2 is plotted in the graph RH. An upper limit and a lower limit of the charging current are plotted in the graph RH. The upper and lower limits of the charging current can be determined based on, for example, (i) the specification of the rechargeable battery constituting the power-supply unit 50 and/or (ii) the restrictions of a power charging equipment for the power-supply unit 50. This enables a driver to input, for each of the time-series period segments K1 to K4, a new manipulated setting of the charging current within a range partitioned between the upper and lower limits.

That is, a driver can set an updated charging parameter TF for each of the time-series period segments K1 to K4. After termination of setting the updated charging parameter TF, a driver's click of the completion icon BN is selected. A driver can update the previous manipulated setting of the charging voltage to a new manipulated setting of the charging voltage in place of the charging current, or can update both the previous manipulated settings of the charging current and charging voltage to new manipulated settings thereof.

Let us consider a first case where a user wants to charge the power-supply unit 50 of the user's vehicle MV at a user's house while the value of the charging current is sufficiently restricted depending on present power consumption in the driver's house. Let us consider a second case where, if a user can use renewable energy, such as solar energy, the user wants to fully charge the power-supply unit 50 at a user's house without restriction of the charging current. For example, let us consider, as the second case, a case where a user wants to fully charge the power-supply unit 50 while setting the charging current to the upper limit thereof.

For example, for each of the first and second cases, a user can change the present manipulated setting of the charging current during a selected one of the time-series period segments K1 to K4 to a new manipulated setting of the charging current, thus changing the present charging parameter item TF to an updated charging parameter TF.

FIG. 8B illustrates an example that the manipulated setting of the charging current during the time-series period K2 is switched to a new lower manipulated setting of the charging current. This causes the graph RI illustrated in FIG. 8A to be changed to a new graph RI illustrated in FIG. 8B. That is, FIG. 8B illustrates the SOC of the power-supply unit 50 before the switching using a dashed curve, and the SOC of the power-supply unit 50 after the switching using a solid curve.

The SOC of the power-supply unit 50 after the switching illustrated in FIG. 8B shows that setting the manipulated setting of the charging current during the time-series period K2 to be lower enables the charging period KD being greater. FIG. 8B also illustrates that the extension of the charging period KD causes a new time-series period K5 to be added in the graph RI. This enables an updated charging parameter TF to be set for the new time-series period K5.

Returning to the setting routine illustrated in FIG. 2, the vehicular control unit 11 serves as a parameter acquiring unit that performs a task (see step S18) of waiting until an input of updated vehicle parameters has been completed (NO in step S18). Specifically, the vehicular control unit 11 waits until the completion icon BN of each of the setting images GB, GC, GD, GI1, GI2, GJ1, GJ2, and GK has been selectively clicked.

When determining that the completion icon BN of each of the setting images GB, GC, GD, GI1, GI2, GJ1, GJ2, and GK has been selectively clicked (YES in step S18), the vehicular control unit 11 acquires updated vehicle parameters in the respective setting images GB, GC, GD, GI1, GI2, GJ1, GJ2, and GK in step S18. Then, the setting routine proceeds to step S19.

In step S19, the vehicular control unit 11 serves as an updating unit that changes the present vehicle parameters stored in the vehicular storage unit 13 to the respective updated vehicle parameters inputted by a driver. Then, the vehicular control unit 11 stops, in step S20, the prohibition task to accordingly remove the prohibition of traveling of the vehicle MV, and thereafter terminates the setting routine.

Next, the following describes the second part, i.e., the remaining part, of the setting routine carried out by the server control unit 81.

When starting the setting routine, the server control unit 81 determines whether the server control unit 81 has received the legal regulation data request from at least one vehicular device 10 in step S21. Upon determination that the server control unit 81 has received no legal regulation data requests from the vehicular devices 10 (NO in step S21), the server control unit 81 terminates the setting routine.

Otherwise, upon determination that the server control unit 81 has received the legal regulation data request from at least one vehicular device 10 (YES in step S21), the setting routine proceeds to step S22.

In step S22, the server control unit 81 sends the legal regulation data request from at least one vehicular device 10 (YES in step S21), the server control unit 81 sends, to the at least one vehicular device 10, the legal regulation data therefrom, and thereafter, the server control unit 81 terminates the setting routine.

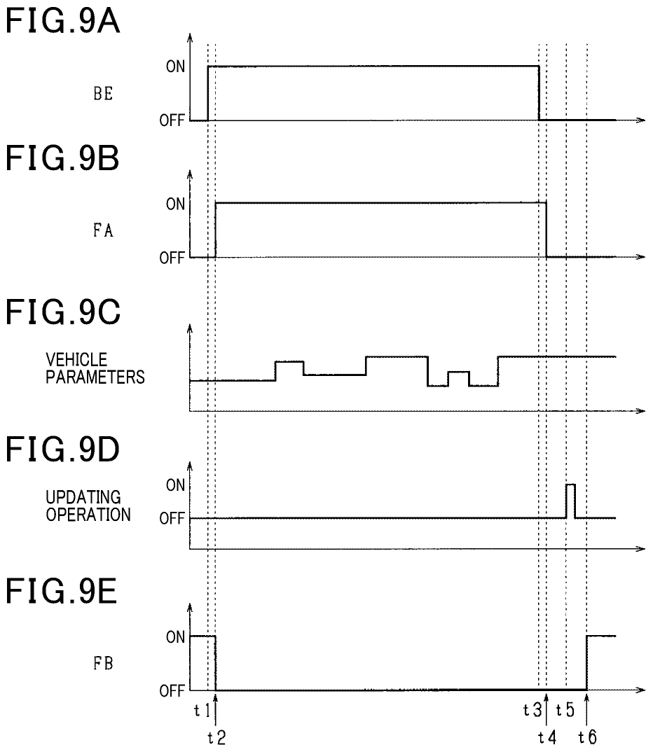

FIGS. 9A to 9E are a joint timing chart illustrating that one example of the setting routine causes each vehicle parameter to be changed during a period defined from a first time of the vehicle parameter setting request being inputted to the vehicular control unit 11 to a second time at which all the vehicle parameters have been updated.

Specifically, FIG. 9A illustrates how the constant setting icon BE changes over time, and FIG. 9B illustrates how a parameter setting mode flag FA changes over time. The parameter setting mode flag FA is controlled to be set to on while a driver's parameter setting working is performed, and to be set to off while no driver's parameter setting working is performed.

FIG. 9C illustrates how the vehicle parameters change over time, FIG. 9D illustrates how an operation of updating the present vehicle parameters is carried out, and FIG. 9E illustrates how a traveling mode flag FB of the vehicle MV changes over time. The traveling mode flag FB represents whether the traveling of the vehicle MV is disabled. The traveling mode flag FB is therefore controlled to be set to on while the traveling of the vehicle MV is enabled, and to be set to off while the traveling of the vehicle MV is disabled.

As illustrated in FIGS. 9A to 9E, clicking the parameter setting icon BE turns the parameter setting icon BE on at time t1, resulting in the parameter setting mode flag FA being turned on and the traveling mode flag FB being turned on at time t2. The turn-on of each of the flags FA and FB enables a driver to perform a setting work of setting updated vehicle parameters using the setting images GB, GC, GD, GI1, GI2, GJ1, GJ2, and GK. FIG. 9C shows that the present vehicle parameters are changed by the driver's setting work to the updated vehicle parameters.

After completion of the driver's setting work, clicking the completion icon BN of each of the setting images GB, GC, GD, GI1, GI2, GJ1, GJ2, and GK at time t3 turns the parameter setting icon BE off, resulting in the parameter setting mode flag FA being turned off at time t4. After the time t4, the present vehicle parameters are respectively changed to the updated vehicle parameters at time t5, and thereafter, the traveling mode flag FB is turned off at time t6.

Next, the following describes advantageous benefits achieved by the first embodiment.

At least one vehicle parameter, which has been previously fixed to be stored in the vehicular storage unit 13, may decrease the driver's drivability of the vehicle MV if the fixed at least one vehicle parameter does not match a driver's expected output of a corresponding at least one driving unit.

From this viewpoint, the first embodiment is configured to enable a driver to enter desired vehicle parameters to accordingly update the present vehicle parameters stored in the vehicular storage unit 13 to the entered vehicle parameters, respectively.

This configuration therefore makes it possible to, even if at least one vehicle parameter stored in the vehicular storage unit 13 does not match a driver's expected output of a corresponding at least one driving unit, update the previously stored at least one vehicle parameter to at least one driver's inputted new vehicle parameter that matches the driver's expected output of the corresponding at least one driving unit. This improves both the driver's drivability of each vehicle MV and the comfort of people in the interior of the corresponding vehicle MV.

Each vehicle MV, which is configured to select, as its driving mode, one of the predetermined plural driving modes, has at least one vehicle parameter corresponding to each of the driving modes. That is, although switching a current driving mode to another driving mode enables at least one vehicle parameter for the current driving mode to be switched to another at least one vehicle parameter for the switched other driving mode, the at least one vehicle parameter corresponding to each driving mode may not match a driver's expected output of a corresponding at least one driving unit.

From this viewpoint, the first embodiment is configured to individually update at least one vehicle parameter for each driving mode to at least one new vehicle parameter. This therefore makes it possible to implement that
(I) Switching a current driving mode to another driving mode enables at least one vehicle parameter for the current driving mode to be switched to another at least one vehicle parameter for the switched other driving mode
(II) Detailed setting of at least one vehicle parameter for each driving mode inputted by a driver

The first embodiment is configured to determine an upper limit and a lower limit of each vehicle parameter. This configuration therefore permits a driver to input at least one vehicle parameter within the range between the upper and lower limits of the at least one vehicle parameter. This therefore prevents mistaken inputs of at least one vehicle parameter, which lies outside the range of the upper and lower limits of the at least one vehicle parameter, thus preventing the occurrence of a malfunction and/or earlier deterioration in the driving unit 30 due to the mistaken inputs.

The first embodiment is configured such that the server storage unit 83, which is located outside each vehicle MV, stores the legal regulation data that is used for determining the upper limit and lower limits of each vehicle parameter. This configuration therefore enables, in response to official change of the legal regulation data, change of the entire legal regulation data stored in the server storage unit 83 and used by each vehicle MV, making it possible to change the legal regulation data more immediately and more easily.

### First Modification of First Embodiment

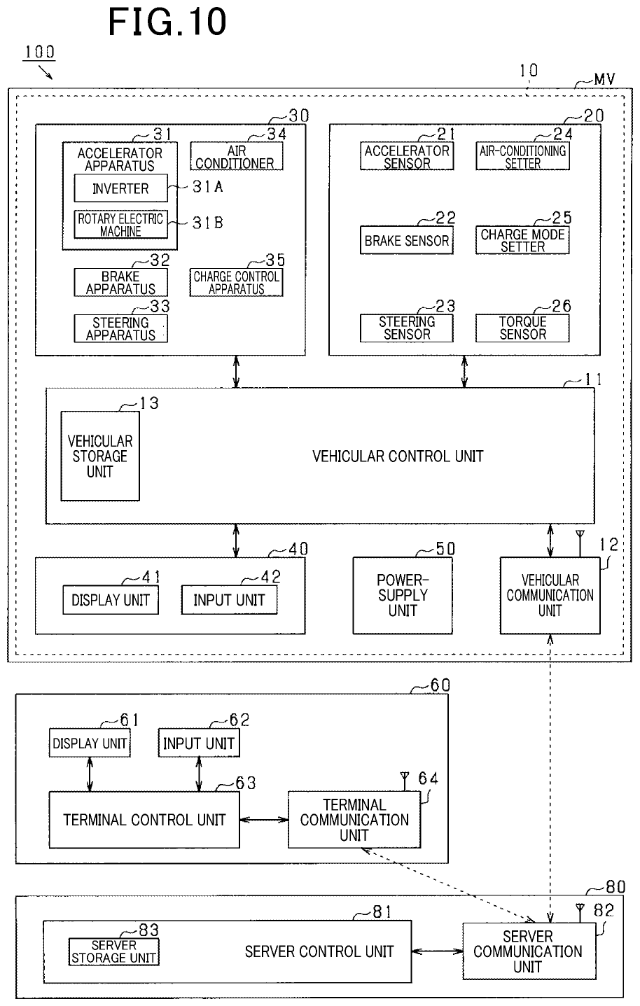

A driver of each vehicle MV can carry a handheld terminal 60 (see FIG. 10). The handheld terminal 60 can enable, in place of the user interface 40, the driver to input, to the vehicular device 10, updated vehicle parameters. Then, the handheld terminal 60 of each vehicle MV can transmit the inputted updated vehicle parameters to the vehicular control unit 11. The handheld terminal 60 can be comprised of, for example, a smartphone or a tablet computer. In the first modification, the user interface 40 can be installed in each vehicle MV or cannot be installed in each vehicle MV.

### Second Modification of First Embodiment

The second modification of the first embodiment shows a detailed configuration of a drive system 100 in which the handheld terminal 60 for a driver of each vehicle MV is used as a driver's input terminal in place of the user interface 40.

As illustrated in FIG. 10, the drive system 100 of each vehicle MV includes the vehicular device 10, the handheld terminal 60, and the server apparatus 80. At least part of the various tasks carried out by the vehicular control unit 11 according to the first embodiment are carried out by the server control unit 81 according to the second modification.

The handheld terminal 60 includes a display unit 61 and an input unit 62. For example, the handheld terminal 60 includes a touch-panel display serving as the display unit 61, and the input unit 62 includes various icons displayed on the touch-panel display of the display unit 61 the input unit 42.

The handheld terminal 60 also includes a terminal control unit 63 and a terminal communication unit 64. The terminal communication unit 64 has a first function of transmitting, via the communication network, information items inputted through the input unit 42 to the server apparatus 80, and a second function of receiving, via the communication network, information items transmitted from the server apparatus 80, and displaying the received information items on the display unit 61.

The terminal control unit 63 is comprised of, for example, at least one microcomputer essentially including a CPU, a ROM, a RAM, and/or a flash memory.

The drive system 100 according to the second modification is configured such that the vehicle parameters are previously stored in the server storage unit 83. The server storage unit 83 according to the second modification serve as a storage unit, and the server control unit 81 according to the second modification serves as a control apparatus.

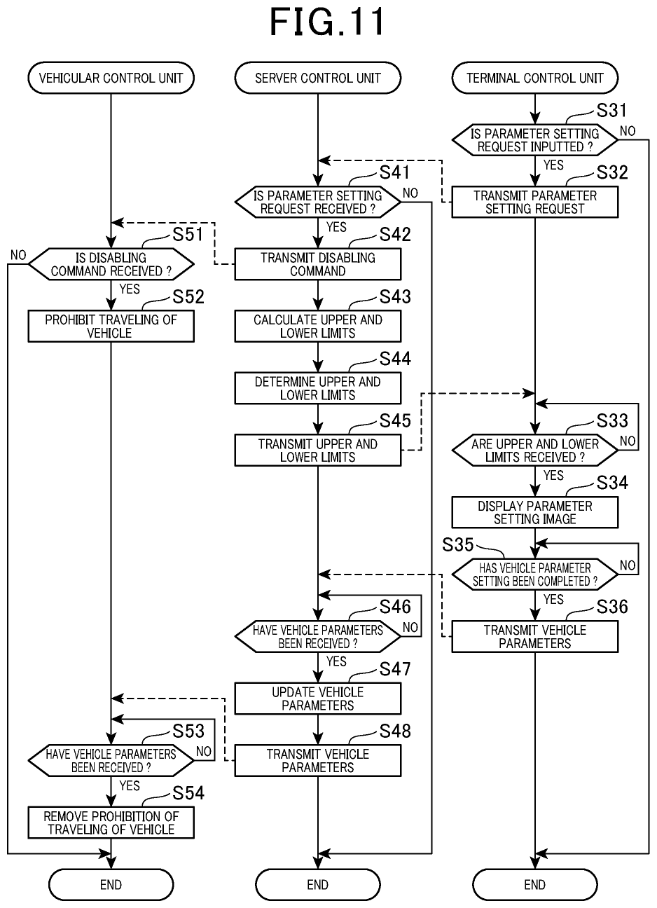

FIG. 11 illustrates a flowchart of a setting routine according to the second modification. The vehicular control unit 11, the server control unit 81, and the terminal control unit 63 are programmed to carry out the setting routine.

First, the following describes the first part of the setting routine carried out by the terminal control unit 63.

When starting the setting routine, the terminal control unit 63 determines whether a vehicle parameter setting request is inputted thereto through the input unit 62 in step S31. If the setting image GA is displayed on the display unit 41 in response to a driver's input operation, and the parameter setting icon BE is selected by a driver through the input unit 62, the terminal control unit 63 determines that the vehicle parameter setting request is inputted thereto through the input unit 62 (YES in step S31). Then, the setting routine proceeds to step S32. Otherwise, when determining that the parameter setting icon BE has not been selected by a driver through the input unit 62, the terminal control unit 63 determines that the vehicle parameter setting request is not inputted thereto through the input unit 62 (NO in step S31), terminating the setting routine.

In step S32, the terminal control unit 63 transmits, to the server apparatus 80 through the terminal communication unit 64, a request input signal indicative of the input of the setting request thereto. Next, the terminal control unit 63 performs a determination task (see step S33) of waiting until receiving upper and lower limits for each vehicle parameter from the server apparatus 80 in response to the request input signal (NO in step S33).

When determining that the terminal control unit 63 has received the upper and lower limits for each vehicle parameter (YES in step S33), the terminal control unit 63 displays the parameter setting image GB on the display unit 61 in step S34. Then, the terminal control unit 63 performs a task (see step S35) of waiting until an input of updated vehicle parameters has been completed (NO in step S35).

When determining that the input of updated vehicle parameters has been completed (YES in step S35), the terminal control unit 63 receives updated vehicle parameters inputted by a driver, and transmits, to the server apparatus 80, the updated vehicle parameters in step S36, and thereafter the terminal control unit 63 terminates the setting routine.

Next, the following describes the second part of the setting routine carried out by the server control unit 81.

When starting the setting routine, the server control unit 81 determines whether the server control unit 81 has received the request input signal from the handheld terminal 60 in step S41.

Upon the server control unit 81 determining that the server control unit 81 has not received the request input signal (NO in step S41), the server control unit 81 terminates the setting routine.

Otherwise, upon the server control unit 81 determining that the server control unit 81 has received the request input signal (YES in step S41), the setting routine proceeds to step S42.

In step S42, the server control unit 81 transmits, to the vehicular device 10 through the server communication unit 82, a disabling command for disabling traveling of the vehicle MV in step S42. Thereafter, the setting routine proceeds to step S43.

In step S43, the server control unit 81 serves as an upper-lower limit determiner to calculate the upper and lower limits for each of the vehicle parameters in accordance with the legal regulation data stored in the server storage unit 83. Next, the server control unit 81 determines the calculated upper and lower limits for each of the vehicle parameters as upper and lower limits for the corresponding one of the vehicle parameters in step S44. After the operation in step S44, the setting routine proceeds to step S45. Specifically, the server control unit 81 calculates the upper and lower limits for each of the vehicle parameters, making it possible to eliminate the need of transmitting the legal regulation data and receiving the legal regulation data.

In step S45, the server control unit 81 serves as a permission unit that transmits, to the handheld terminal 60 through the server communication unit 82, the upper and lower limits for each of the vehicle-parameters, thus permitting a driver to input new vehicle parameters, and thereafter, the setting routine proceeds to step S46.

The server control unit 81 serves as a parameter acquiring unit to perform a determination task (see step S46) of waiting until acquiring updated vehicle parameters in response to the permission from the handheld terminal 60 (NO in step S46).

When determining that the server control unit 81 has acquired the updated vehicle parameters from the handheld terminal 60 (YES in step S46), the server control unit 81 serves as the updating unit to update the present vehicle parameters stored in the server storage unit 83 to the respective updated vehicle parameters inputted by a driver in step S47. Then, the server control unit 81 transmits, to the vehicular device 10 through the server communication unit 82, the updated vehicle parameters in step S48, and thereafter terminates the setting routine.

Next, the following describes the third part of the setting routine carried out by the vehicular control unit 11.

When starting the setting routine, the vehicular control unit 11 determines whether the vehicular control unit 11 has received the disabling command from the server apparatus 80 in step S51.

Upon the vehicular control unit 11 determining that the vehicular control unit 11 has not received the disabling command (NO in step S51), the vehicular control unit 11 terminates the setting routine.

Otherwise, upon the vehicular control unit 11 determining that the vehicular control unit 11 has received the disabling command (YES in step S51), the setting routine proceeds to step S52.

In step S52, the vehicular control unit 11 performs a prohibition task of prohibiting traveling of the vehicle MV. The setting routine proceeds to step S53.

The vehicular control unit 11 performs a task (see step S53) of waiting until receiving the updated vehicle parameters from the server apparatus 80 (NO in step S53).

Upon the vehicular control unit 11 receiving the updated vehicle parameters from the server apparatus 80 (YES in step S53), the vehicular control unit 11 stops the prohibition task to accordingly remove the prohibition of traveling of the vehicle MV in step S54, and thereafter terminates the setting routine.

This enables the vehicular control unit 11 to control the driving unit 30 based on the vehicle parameters received in step S53.

As described above, the second modification is configured such that the vehicle parameters are previously stored in the server storage unit 83, and the server control unit 81 respectively updates the vehicle parameters to new ones.

This configuration therefore reduces a processing load of the vehicular control unit 11 of each vehicle MV. Additionally, if a driver wants to drive a selected one of rental/shared vehicles as an example of the vehicles MV, and the driver has already driven one of the other rental/shared vehicles, it is possible to refer to the vehicle parameters on the driven rental/shared vehicle stored in the server storage unit 83 to accordingly input updated vehicle parameters about the selected one of the rental/shared vehicles.

### Second Embodiment

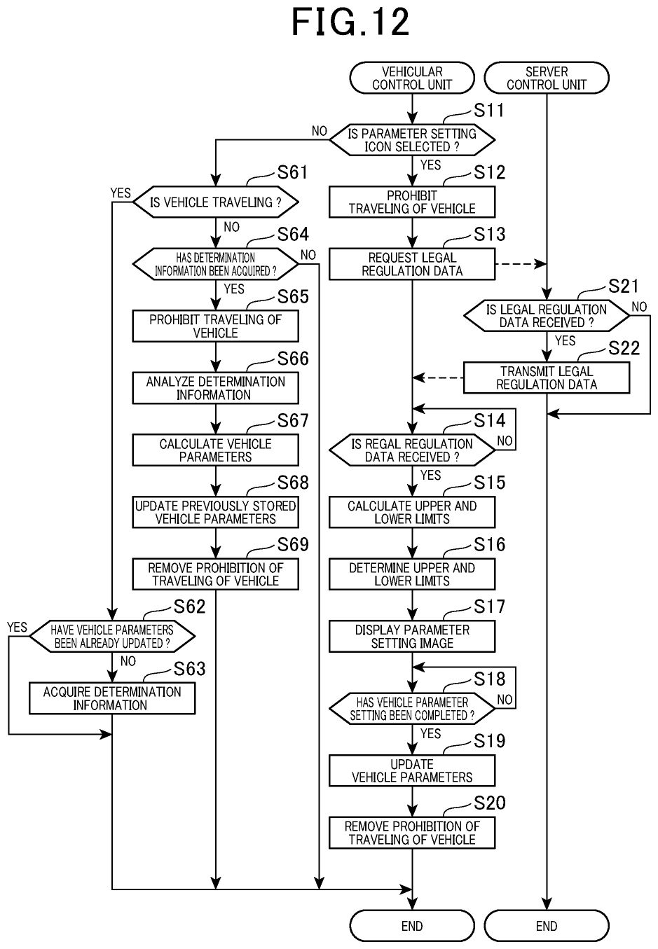

The following describes the second embodiment with reference to FIG. 12. In particular, the following describes mainly different points of the second embodiment as compared with the first embodiment.

Specifically, the setting routine of the second embodiment, which is different from the setting routine of the first embodiment, is designed to
(I) Analyze, if no vehicle parameter setting requests are inputted to the vehicular control unit 11, determination information to accordingly determine driver's operation characteristics
(II) Respectively change the present vehicle parameters to updated ones in accordance with the determined driver's operation characteristics

The determination information on each vehicle MV includes at least one of behavior information on the corresponding vehicle MV, information indicative of environments around the corresponding vehicle MV, which will be referred to as environmental information, and operation information on the corresponding vehicle MV.

The behavior information on each vehicle MV represents the behavior of the vehicle MV while the vehicle MV is traveling. For example, the behavior information includes information about the driver's accelerator opening of the vehicle MV.

The environmental information on each vehicle MV includes, for example, road gradients acquired by the user interface 40 serving as a vehicle navigation system.

The operation information on each vehicle MV represents operation information on each of structural units that constitute the corresponding vehicle MV. The structural units constituting each vehicle MV include the driving unit 30 and other components in the corresponding vehicle MV.

The determination information on each vehicle MV additionally includes driver information that identifies a driver of the corresponding vehicle MV. For example, if a device that can identify a driver, such as a driver status monitor (DSM), is installed in each vehicle MV, the driver information on each vehicle MV is used as the information on a driver of the corresponding vehicle MV identified by the device. As another example, if identification information (ID) about a driver of each vehicle MV is inputted by the input unit 42, the inputted ID is used as the driver information about the driver.

FIG. 12 illustrates a flowchart of the setting routine according to the second embodiment. Description of operations in the setting routine illustrated in FIG. 12, which are respectively identical to operations in the setting routine illustrated in FIG. 2, is omitted while identical step numbers are assigned to respective identical operations between the setting routines illustrated in respective FIGS. 2 and 12.

Referring to FIG. 12, upon determination that the vehicle parameter setting request is not inputted thereto through the input unit 42 so that no vehicle parameters are inputted by a driver (NO in step S11), the setting routine proceeds to step S61.

In step S61, the vehicular control unit 11 determines whether the vehicle MV is traveling based on, for example, the speed of the vehicle MV measured by an unillustrated vehicle speed sensor.

Upon determination that the vehicle MV is traveling (YES in step S61), the setting routine proceeds to step S62. Otherwise, upon determination that the vehicle MV is not traveling (NO in step S61), the setting routine proceeds to step S64.

In step S62, the vehicular control unit 11 determines whether the vehicle parameters have been already updated. Specifically, the vehicular control unit 11 acquires the driver information included in the determination information to accordingly identify a driver of the vehicle MV. Then, the vehicular control unit 11 determines whether the vehicle parameters have been updated by the identified driver one or more times. If the vehicle parameters have been updated in step S19 or step S67, which will be described later, of the last setting routine or a previous setting routine before the last setting routine, the determination in step S62 is YES, so that the vehicular control unit 11 terminates the setting routine.

Otherwise, upon determination that the vehicle parameters have not been updated yet (NO in step S62), the vehicular control unit 11 serves as a determination information acquiring unit to acquire the determination information in step S63. For example, the vehicular control unit 11 acquires the determination information except the driver information in step S63. Thereafter, the vehicular control unit 11 terminates the setting routine.

In step S64, the vehicular control unit 11 determines whether the determination information has been acquired. If the determination information has been acquired in step S63 of the last setting routine or a previous setting routine before the last setting routine, the determination in step S64 is YES, so that the setting routine proceeds to step S65. Otherwise, if the determination information has not been acquired (NO in step S64), the vehicular control unit 11 terminates the setting routine.

Like step S12, in step S65, the vehicular control unit 11 performs a prohibition task of prohibiting traveling of the vehicle MV. Next, the vehicular control unit 11 analyzes the determination information in step S66. Specifically, the vehicular control unit 11 analyzes the determination information to accordingly determine the driver's operation characteristics in step S66, and thereafter the setting routine proceeds to step S67.

The following describes the operation in step S66 using the accelerator opening and the brake stroke as examples of the determination information.

First, the following describes a first operation instance in step S66 using the accelerator opening as an example of the determination information.

If the accelerator parameter TA previously determined at a driver's selected value of the accelerator opening does not match a driver's expected output of the accelerator apparatus 31, a driver may frequently change a value of the accelerator opening to cause the accelerator apparatus 31 to output driver's expected driving torque, resulting in these driver's frequent changes of the accelerator opening becoming non-smooth.

From this viewpoint, the vehicular control unit 11 analyzes, based on, for example, the information about road gradients included in the determination information, change in driver's selected values of the accelerator opening using a known interval average method and/or a known interval variance method to accordingly determine, as the driver's operation characteristics, a degree of smoothness of the driver's operations.

Following the operation in step S66, the vehicular control unit 11 calculates, based on the driver's operation characteristics determined in step S66, corrected vehicle parameters that enable change of the driver's operations of the vehicle MV to be smoother in step S67.

The following describes the operation in step S67 using the accelerator opening as an example of the determination information. If a driver of the vehicle MV frequently changes a value of the accelerator opening despite the road on which the vehicle MV is traveling being flat, the vehicular control unit 11 calculates a corrected accelerator parameter TA that causes driving torque of the accelerator apparatus 31 to become greater than previous driving torque thereof determined based on the previous accelerator parameter TA within an input range defined by the upper and lower limits.

The following describes a second operation instance in step S66 using the driver's accelerator opening as an example of the determination information.

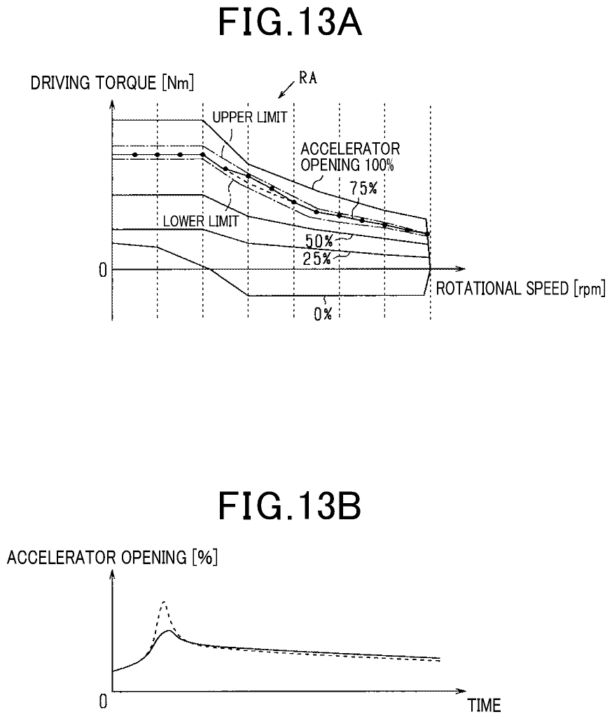

FIG. 13A illustrates, as a dashed curve, a present accelerator parameter TA previously determined at a driver's selected value of 75% of the accelerator opening does not match a driver's expected output of the accelerator apparatus 31. At that time, during acceleration of the vehicle MV, a driver may excessively increase the accelerator opening to cause the accelerator apparatus 31 to output intended driving torque (see a dashed curve in FIG. 13B). This may result in a temporarily steep increase appearing in the time-series change of the accelerator opening.

From this viewpoint, the vehicular control unit 11 determines, based on the time-series change of the accelerator opening stored in the vehicular storage unit 13, whether temporarily steep increases appear in frequent periods in step S66.

Upon determination that temporarily steep increases appear in frequent periods (YES in step S66), the vehicular control unit 11 changes a value of the driving torque, which is based on the present accelerator parameter TA and linked to a value of the rotational speed of the rotary electric machine 31B in each of these frequent periods, to be higher as an updated accelerator parameter TA. The value of the rotational speed of the rotary electric machine 31B in each frequent time can be determined in accordance with a time-series change of the rotational speed of the rotary electric machine 31B stored in the vehicular storage unit 13.

In the example illustrated in FIG. 13A, if determining, based on the driver's operation characteristics, that a value of the driving torque based on the previously determined accelerator parameter TA at 75% of the accelerator opening is low within a middle range of the rotational speed of the rotary electric machine 31B, the vehicular control unit 11 calculates an updated accelerator parameter TA having a value of the driving torque at 75% of the accelerator opening within the middle range of the rotational speed of the rotary electric machine 31B; the value of the driving torque is higher than the corresponding value of the driving torque based on the previously determined accelerator parameter TA.

This curbs, as illustrated in a solid curve FIG. 13B, excessive increases in the accelerator opening, enabling change of the driver's operations of the accelerator opening to be smoother.

The timing at which change of a value of the driving torque is carried out is not limited to a specific percentage of, for example, 75%, and can be set to any percentage of the accelerator opening. For example, a value of the driving torque can be changed for each sampled value of the accelerator opening. As another example, sequential values of the driving torque can be changed for each of the frequent periods of the accelerator opening.

Next, the following describes a third operation instance in step S66 using the brake stroke as an example of the determination information.

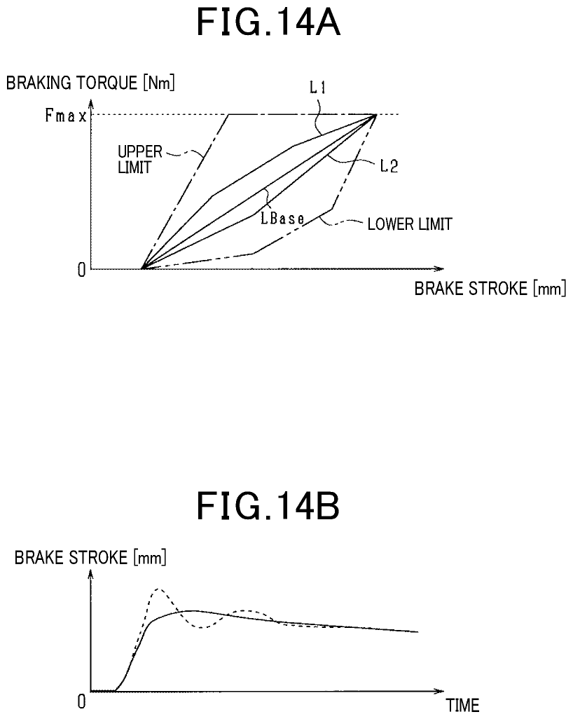

FIG. 14A illustrates first to third change patterns of the braking torque correlating with an increase in the brake stroke. The first change pattern of the braking torque, which changes linearly with an increase in the brake stroke, is defined as a base pattern LBase. The second change pattern of the braking torque, which is located greater than the base pattern, is defined as a first pattern L1. That is, as compared with the base pattern LBase, the first pattern L1 of the braking torque becomes more effective with a driver's depression of the brake pedal. The third change pattern of the braking torque, which is located smaller than the base pattern, is defined as a second pattern L2. That is, as compared with the base pattern LBase, the second pattern L2 of the braking torque becomes less effective with a driver's depression of the brake pedal. The brake parameter TB has three change patterns respectively corresponding to the change patterns LBase, L1, and L2. That is, shift of one of the change patterns of the brake parameter TB to another one of the change patterns of the brake parameter TB causes a corresponding one of the change patterns LBase, L1, and L2 to shift to corresponding another one of the change patterns LBase, L1, and L2.

For example, the present change pattern of the brake parameter TB is set to match the change pattern LBase of the braking torque, and does not match a driver's expected output of the braking torque. At that time, during deceleration of the vehicle MV, a driver may frequently increase the brake stroke to cause the brake apparatus 32 to output intended braking torque (see a dashed curve in FIG. 14B). This may result in these driver's frequent changes of the brake stroke becoming non-smooth. This may result in an excessively changing period of the braking torque increasing in the time-series change of the braking torque.

From this viewpoint, the vehicular control unit 11 determines, based on the time-series change of the brake stroke stored in the vehicular storage unit 13, whether the period of excessive braking-torque change has become prolonged in step S66. For example, when determining that a period for which a change in the brake stroke has exceeded a predetermined threshold period, the vehicular control unit 11 determines that the period of excessive braking-torque change has become prolonged in step S66.

Upon determination that the period of excessive braking-torque change has become prolonged (YES in step S66), the vehicular control unit 11 changes a value of the braking torque, which is based on the present brake parameter TB and linked to an excessively changing range of the braking torque, to be higher as an updated brake parameter TB. The excessively changing range of the braking torque can be determined in accordance with a time-series change of the brake stroke stored in the vehicular storage unit 13.

In the example illustrated in FIG. 14A, if determining, based on the driver's operation characteristics, that a value of the braking torque based on the basic pattern LBase is low, the vehicular control unit 11 calculates an updated brake parameter TB that matches the first pattern L1 that is located to be higher than the basic pattern LBase.

This curbs, as illustrated in a solid curve FIG. 14B, variations in the braking torque, enabling driver's change of the braking torque to be smoother.

Following the operation in step S67, in step S68, the vehicular control unit 11 serves as the updating unit that changes the present vehicle parameters stored in the vehicular storage unit 13 to the respective updated vehicle parameters calculated in step S67. Then, the vehicular control unit 11 stops, in step S69, the prohibition task to accordingly remove the prohibition of traveling of the vehicle MV, and thereafter terminates the setting routine.

Next, the following describes advantageous benefits achieved by the second embodiment.

If a driver wants to update at least one vehicle parameter, the driver may not update the at least one vehicle parameter, because the driver does not recognize an updated detail of the at least one vehicle parameter, which matches a driver's expected output of at least one target driving unit. Additionally, even if a driver recognizes an updated detail of at least one vehicle parameter, which matches a driver's expected output of at least one target driving unit, the driver may not update the at least one vehicle parameter in a case where
(I) The driver does not recognize one or more other vehicle parameters
(II) The at least one vehicle parameter is not an optimum parameter when combined with the one or more other vehicle parameters

From this viewpoint, the vehicular control unit 11 of the second embodiment is configured to analyze, if no updated vehicle parameters are inputted thereto, the determination information to accordingly update the present vehicle parameters to new ones in accordance with the determined driver's operation characteristics acquired by the analyzing of the determination information.

This configuration of the vehicular control unit 11 therefore makes it possible to update the present vehicle parameters to new ones that are suitable for the driver even if the driver does not input the new vehicle parameters to the vehicular control unit 11, resulting in no need of frequently changing values of one or more driver's manipulated variables required to acquire desired driving power of the driving unit 30.

The behavior information included in the determination information on each vehicle MV may include (i) at least one of speed information of the vehicle MV, (ii) information about the rotational speed of the rotary electric machine 31B, (iii) information about the driving torque of the vehicle MV, (iv) information about the driver's accelerator opening, (v) information about the brake stroke, (vi) information indicative of the ecological mode being selected as the driving mode, (vii) information indicative of the sport mode being selected as the driving mode, and (viii) information about regenerative energy.

The environmental information included in the determination information on each vehicle MV may include (i) information on GPS location data indicative of the current location of the vehicle MV, (ii) information about the road on which the vehicle MV is traveling, (iii) information about the height of the traveling vehicle MV, (iv) information indicative of a region in which the vehicle MV is traveling, (v) information indicative of the conditions of the surface of the road on which the vehicle MV is traveling, (vi) information about a season during which the vehicle MV is traveling, (vii) information about the outside temperature at which the vehicle MV is traveling, (viii) information about the time zone during which the vehicle MV is traveling, (ix) information about the number of occupant(s) in the vehicle MV, (x) information about the weight of cargo in the vehicle MV, (xi) information about gears connected to the rotary electric machine 31B of the vehicle MV, (xii) information about millimeter waves used for detection of objects located around the vehicle MV, (xiii) information about ultrasonic waves used by an ultrasonic sonar for detection of objects located around the vehicle MV, (xiv) information about a buzzer sound at the detection of objects located around the vehicle MV, (xv) traffic information around the vehicle MV, and (xvi) information about the occurrence of events around the vehicle MV.

The operation information included in the determination information on each vehicle MV includes (i) information indicative of the SOC of the power-supply unit 50, (ii) information indicative of the degree of deterioration of the power-supply unit 50, (iii) information indicative of the efficiency of the power-supply unit 50, (iv) information indicative of the output voltage of the power-supply unit 50, (v) information indicative of the output current of the power-supply unit 50, (vi) information indicative of the number of charging of the power-supply unit 50, (vii) information on video files recorded by a drive recorder while the vehicle MV is traveling, (viii) information on how the headlights are turned on or off, (ix) information on how the wipers work, (x) information indicative of the temperature setting for the air-conditioner changes, (xi) information indicative of the outside temperature changes, (xii) information indicative of the temperature inside the vehicle MV, (xiii) information indicative of the rotational speed of the blower fan, (xiv) information indicative of the operating temperature of the heater, (xv) information indicative of the total travel distance of the vehicle Mv, (xvi) information indicative of the amount of heat generated by each component of the vehicle MV, (xvii) information indicative of the temperature of each component of the vehicle MV, (xix) information indicative of how the compressor works, (xx) information indicative of the cooling temperature, (xxi) information indicative of how audio devices are used, (xxii) information indicative of status of warning indicators, (xxiii) information indicative of how warning sound is outputted, (xxiv) information indicative of the pressure of each tire, and (xxv) service cooperative information.

The determination information on each vehicle MV may include biological information on a driver of the vehicle MV, service cooperative information, and insurance information about the vehicle MV.

### Third Embodiment

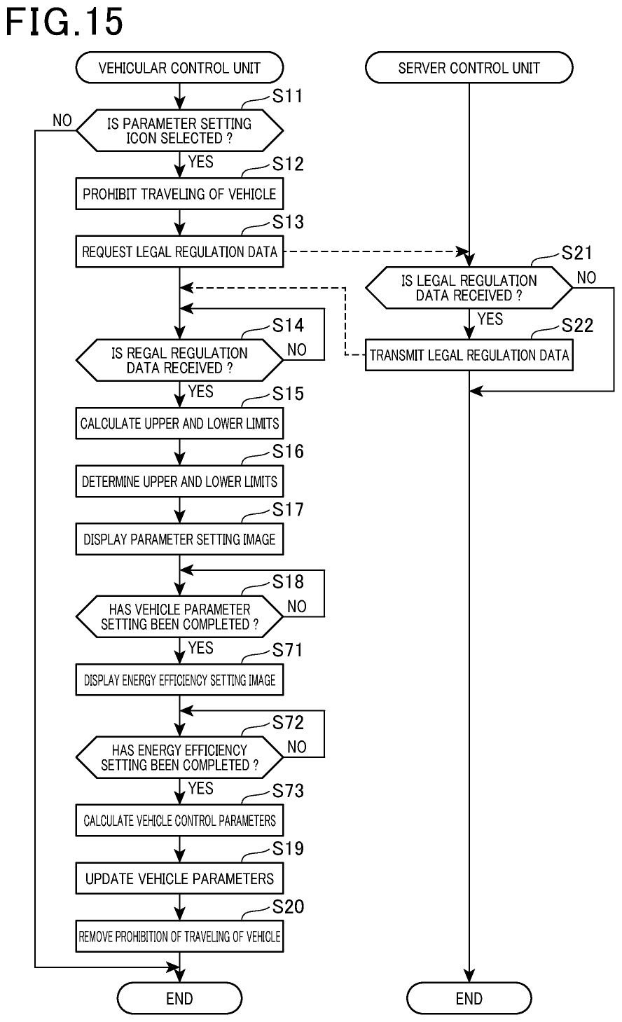

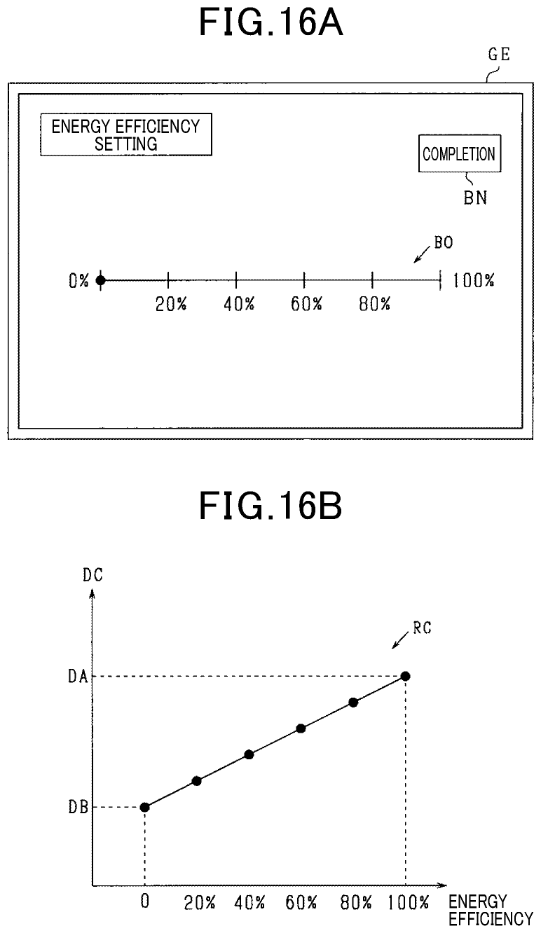

The following describes the third embodiment with reference to FIGS. 15, 16A, and 16B. In particular, the following describes mainly different points of the third embodiment as compared with the first embodiment.

Specifically, the setting routine of the third embodiment, which is different from the setting routine of the first embodiment, is designed to enable a driver to input a value of the energy efficiency of the vehicle MV.

The energy efficiency of the vehicle MV changes depending on the driving parameters of the driving unit 30, and the driving parameters of the driving unit 30 change depending on the vehicle parameters. In each vehicle MV, the vehicle parameters include an efficient constant DA that enables the energy efficiency of the vehicle MV to become highest. The efficient constant DA is stored in the vehicular storage unit 13. The efficient constant DA may be different from a value of an input parameter DB included in the vehicle parameters and inputted by a driver of the vehicle MV. The vehicular device 10 is configured to enable a setting parameter DC, which is based on the energy efficiency and included in the vehicle parameters, to be determined between the efficient constant DA and the inputted value of the input parameter DB inclusive.

FIG. 15 illustrates a flowchart of the setting routine according to the third embodiment. Description of operations in the setting routine illustrated in FIG. 15, which are respectively identical to operations in the setting routine illustrated in FIG. 2, is omitted while identical step numbers are assigned to respective identical operations between the setting routines illustrated in respective FIGS. 2 and 15.

Referring to FIG. 15, when determining that the completion icon BN of each of the setting images GB, GC, GD, GI1, GI2, GJ1, GJ2, and GK has been selectively clicked (YES in step S18), the vehicular control unit 11 permits a driver to input an energy efficiency in step S71, and thereafter, the setting routine proceeds to step S72. Specifically, in step S71, the vehicular control unit 11 displays an energy efficiency setting image GE on the display unit 41. This enables a driver's input of an updated energy efficiency.

FIG. 16A illustrates the energy efficiency setting image GE.

The energy efficiency setting image GE includes an energy-efficiency setting icon BO for setting the energy efficiency of the vehicle MV, and the completion icon BN.

The efficiency setting icon BO is designed as a slidable icon that enables a desired value of the energy efficiency to be freely set between 0% and 100% inclusive.

FIG. 16B illustrates a graph RC showing a relationship between values of the energy efficiency and corresponding values of the setting parameter DC, i.e., the efficient constant DA and the inputted value of the input parameter DB.

FIG. 16B shows that, when the energy efficiency is set to 0%, the setting parameter DC becomes equal to the input value of the input parameter DB, and, when the energy efficiency is set to 100%, the setting parameter DC becomes equal to the efficiency constant DA. FIG. 16B also shows that, when the energy efficiency is set to X % between 0% and 100% exclusive, the setting parameter DC can be calculated based on the efficiency constant DA and the inputted value of the input parameter DB as a value between the efficiency constant DA and the inputted value of the input parameter DB.

Specifically, the setting parameter DC can be expressed by the following linear approximation expression [eq1] based on the efficiency constant DA and the inputted value of the input parameter DB:

DC=DA+(DB−DA)×X/100 [eq1]

If the efficiency constant DA is equal to the inputted value of the input parameter DB, the setting parameter DC becomes equal to the efficiency constant DA and the inputted value of the input parameter DB independently of the energy efficiency. After termination of setting the energy efficiency, the driver's click of the completion icon BN is selected.

Following the operation in step S71, the vehicular control unit 11 serves as an efficiency information acquiring unit that performs a task (see step S72) of waiting until setting of the energy efficiency has been completed (NO in step S72). Specifically, the vehicular control unit 11 waits until the completion icon BN of the energy efficiency setting image GE has been selectively clicked.

When determining that the completion icon BN of the energy efficiency setting image GE has been selectively clicked (YES in step S72), the vehicular control unit 11 acquires, as efficiency information, a driver's inputted value (X %) of the energy efficiency in step S72, and the setting routine proceeds to step S73.

In step S73, the vehicular control unit 11 calculates, based on the driver's inputted value (X %) of the energy efficiency and the expression [eq1], a value of the setting parameter DC. Then, the setting routine proceeds to step S19.

Next, the following describes advantageous benefits achieved by the third embodiment.

If a driver inputs a value of the input parameter DB that is different from the efficient constant DA, the energy efficiency of the vehicle MV may be reduced although the drivability of the vehicle MV is improved.

From this viewpoint, the vehicular control unit 11 of the third embodiment is configured to update, based on the efficient constant DA, the present vehicle parameters stored in the vehicular storage unit 13 to new ones.

This configuration of the vehicular control unit 11 therefore makes it possible to improve both the energy efficiency and drivability of the vehicle MV.

### Fourth Embodiment

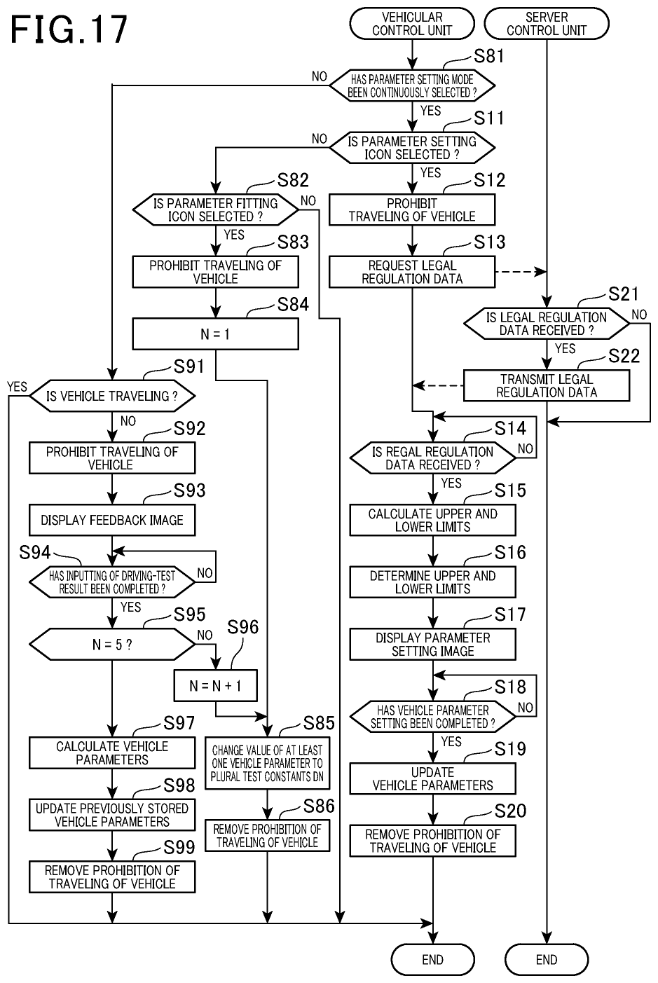

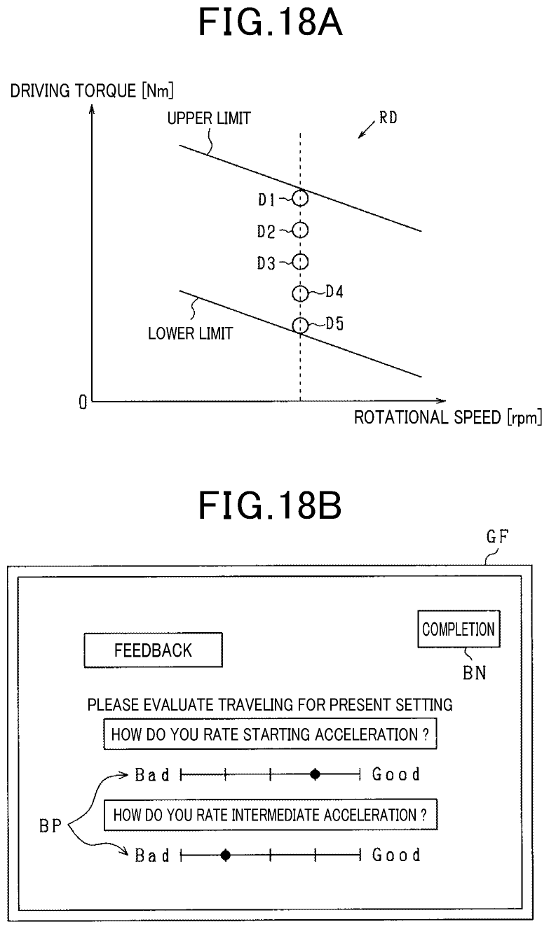

The following describes the fourth embodiment with reference to FIGS. 17 and 18. In particular, the following describes mainly different points of the fourth embodiment as compared with the first embodiment.

Specifically, the setting routine of the fourth embodiment, which is different from the setting routine of the first embodiment, is designed to perform a parameter fitting task that determines whether at least one of the vehicle parameters, which has been set by a driver, matches a driver's expected output of a corresponding at least one target driving unit of the vehicle MV.

In order to update at least one of the vehicle parameters stored in the vehicular storage unit 13 independently of a driver's input of a new value of the at least one of the vehicle parameters, the vehicular control unit 11 is configured to acquire feedback information based on the behavior of the vehicle MV while the vehicle MV is traveling.

The feedback information according to the fourth embodiment includes information on driver's inputted responses in response to predetermined queries concerning the drivability of the vehicle MV.

The vehicular control unit 11 is also configured to update at least one of the vehicle parameters stored in the vehicular storage unit 13 in accordance with the feedback information.

FIG. 17 illustrates a flowchart of the setting routine according to the fourth embodiment. Description of operations in the setting routine illustrated in FIG. 17, which are respectively identical to operations in the setting routine illustrated in FIG. 2, is omitted while identical step numbers are assigned to respective identical operations between the setting routines illustrated in respective FIGS. 2 and 17.

Referring to FIG. 17, when starting the setting routine, the vehicular control unit 11 determines whether a parameter setting mode has been continuously selected in step S81. Upon determination that the parameter fitting icon BF in the setting image GA was selected so that the parameter setting mode has been continuously selected in step S82, which will be described later, of the last setting routine or a previous setting routine before the last setting routine, the vehicular control unit 11 determines that the parameter setting mode has been continuously selected (YES in step S81), the setting routine proceeding to step S91.

Otherwise, upon determination that the parameter setting mode has not been continuously selected (NO in step S81), the setting routine proceeds to step S11.

When determining that the vehicle-parameter setting request is inputted thereto through the input unit 42 (YES in step S11), the vehicular control unit 11 determines whether a parameter fitting request is inputted thereto through the input unit 42 in step S82.

Specifically, when determining that the setting image GA is displayed on the display unit 41 in response to a driver's input operation while the vehicle MV is stopped, and the parameter fitting icon BF is selected by a driver through the input unit 42, the vehicular control unit 11 determines that the parameter fitting request is inputted thereto through the input unit 42 (YES in step S82), the setting routine proceeding to step S83. Otherwise, when determining that the parameter fitting icon BF is not selected (NO in step S82), the vehicular control unit 11 terminates the setting routine.

In step S83, the vehicular control unit 11 performs the prohibition task of prohibiting traveling of the vehicle MV, and sets, to 1, a fitting count number N, which represents the number of the parameter fitting tasks carried out thereby in step S84. Following the operation in step S84, the vehicular control unit 11 serves as a changing unit to change a value of at least one of the vehicle parameters, such as the driving torque of the rotary electric machine 31B, to plural test constants DN in step S85. Next, the vehicular control unit 11 stops, in step S86, the prohibition task to accordingly remove the prohibition of traveling of the vehicle MV, and thereafter terminates the setting routine.

The test constants DN for each of the vehicle parameters are previously determined within a predetermined input range of the corresponding one of the vehicle parameters. The upper limit of the input range of each of the vehicle parameters is set as one of the test constants DN for the corresponding one of the vehicle parameters, and the lower limit of the input range of each of the vehicle parameters is set as another one of the test constants DN for the corresponding one of the vehicle parameters. If the number of test constants DN for each of the vehicle parameters is set to three or more, the test constants DN for each vehicle parameter within the input range of the corresponding vehicle parameter have constant intervals therebetween.

FIG. 18A illustrates a graph RD showing a relationship between the fitting count number N and the test constants DN for a selected value of the accelerator opening in order to evaluate, for example, the accelerator parameter TA. FIG. 18A shows that, for each sampled value of the accelerator opening, five test constants D1 to D5 used for the parameter fitting task are previously determined for each sampled value of the rotational speed of the rotary electric machine 31B, and stored in the vehicular storage unit 13. This enables a present value of the accelerator parameter TA to be changed to one of the test constants D1 to D5 when the fitting count number N is a corresponding one of 1 to 5.

Following the affirmative determination in step S81, the vehicular control unit 11 determines whether the vehicle MV is traveling in step S91.

Upon determination that the vehicle MV is traveling (YES in step S91), the vehicular control unit 11 terminates the setting routine. That is, during traveling of the vehicle MV, a driving test of the vehicle MV is carried out based on the present value of at least one of the vehicle parameters being set to one of the test constants DN determined for the at least one of the vehicle parameters.

Otherwise, upon determination that the vehicle MV is not traveling (NO in step S91), the vehicular control unit 11 performs a prohibition task of prohibiting traveling of the vehicle MV in step S92. Next, the vehicular control unit 11 permits a driver to input results of the test driving in step S93, the setting routine proceeding to step S94.

Specifically, in step S93, the vehicular control unit 11 displays a feedback image GF on the display unit 41. This enables a driver's input of the results of the test driving.

FIG. 18B illustrates the feedback image GF for permitting a driver to input the results of the test driving in order to evaluate, for example, the accelerator parameter TA using a selected one of the test constants DN. The feedback image GF includes reply input icons BP for inputting the results of the test driving, and the completion icon BN.

Specifically, in the feedback image GF, predetermined plural text queries concerning the drivability of the vehicle MV for the test driving are described, and plural reply input icons BP are displayed for the respective text queries. Each of the reply input icons BP enables a driver to enter a selected one of drivability levels, such as five drivability levels, defined between the minimum drivability level “Bad” and the maximum drivability level “Good”. The minimum drivability level “Bad” of each reply input icon BP represents the test result for the selected one of the test constants DN in response to the corresponding query does not match a driver's expected output of a driving unit, such as the rotary electric machine 31B. The maximum drivability level “Good” of each reply input icon BP represents the test result for the selected one of the test constants DN in response to the corresponding query matches a driver's expected output of a driving unit, such as the rotary electric machine 31B.

In step S94, the vehicular control unit 11 serves as a feedback information acquiring unit that performs a task (see step S94) of waiting until inputting of the results of the driving test based on a selected one of the test constants DN has been completed (NO in step S94). Specifically, the vehicular control unit 11 waits until the completion icon BN of the feedback image GF has been selectively clicked.

When determining that the completion icon BN of the feedback image GF has been selectively clicked (YES in step S94), the vehicular control unit 11 acquires, as the feedback information, the results of the driving test based on a selected one of the test constants DN in step S94, and the setting routine proceeds to step S95.

In step S95, the vehicular control unit 11 determines whether the fitting count number N is 5. Upon determination that the fitting count number N is not 5 (NO in step S95), the vehicular control unit 11 increments the fitting count number N by 1, and thereafter the setting routine proceeds to step S85.

Otherwise, upon determination that the fitting count number N is 5 (YES in step S95), the vehicular control unit 11 calculates, based on the feedback information, corrected vehicle parameters that enable change of the driver's operations to be smoother in step S97.

Following the operation in step S97, in step S98, the vehicular control unit 11 serves as the updating unit that changes the present vehicle parameters stored in the vehicular storage unit 13 to the respective updated vehicle parameters calculated in step S97.

That is, even if the vehicle parameters stored in the vehicular storage unit 13 were changed to driver's inputted new ones in the last setting routine or a previous setting routine before the last setting routine, the vehicular control unit 11 changes the driver's inputted vehicle parameters stored in the vehicular storage unit 13 to the respective updated vehicle parameters calculated in step S97.

Next, the vehicular control unit 11 stops, in step S99, the prohibition task to accordingly remove the prohibition of traveling of the vehicle MV, and thereafter terminates the setting routine.

Next, the following describes advantageous benefits achieved by the fourth embodiment.

For example, at least one driver's inputted vehicle parameter may not match a driver's expected output of at least one driving unit, because a driver's understanding of the vehicle parameters is ambiguous. As another example, the vehicle parameters understood by a driver suitable for a previously selected one of rental/shared vehicles as the vehicle MV may be changed to be unsuitable for a currently selected new one of the rental/shared vehicles as the vehicle MV to be driven; the type, in particular weight, of the currently selected rental/shared vehicle is different from that of the previously selected rental/shared vehicle.

From this viewpoint, the vehicular control unit 11 of the fourth embodiment has a function of performing the parameter fitting task, and is configured to update, based on the feedback information inputted thereto by a driver, the present vehicle parameters stored in the vehicular storage unit 13 to new ones.

This configuration of the vehicular control unit 11 therefore makes it possible to calculate corrected vehicle parameters that are suitable for the driver's style of operating the vehicle independently of the driver's inputted vehicle parameters, resulting in an improvement of the drivability of the vehicle MV based on the calculated vehicle parameters.

### Fifth Embodiment

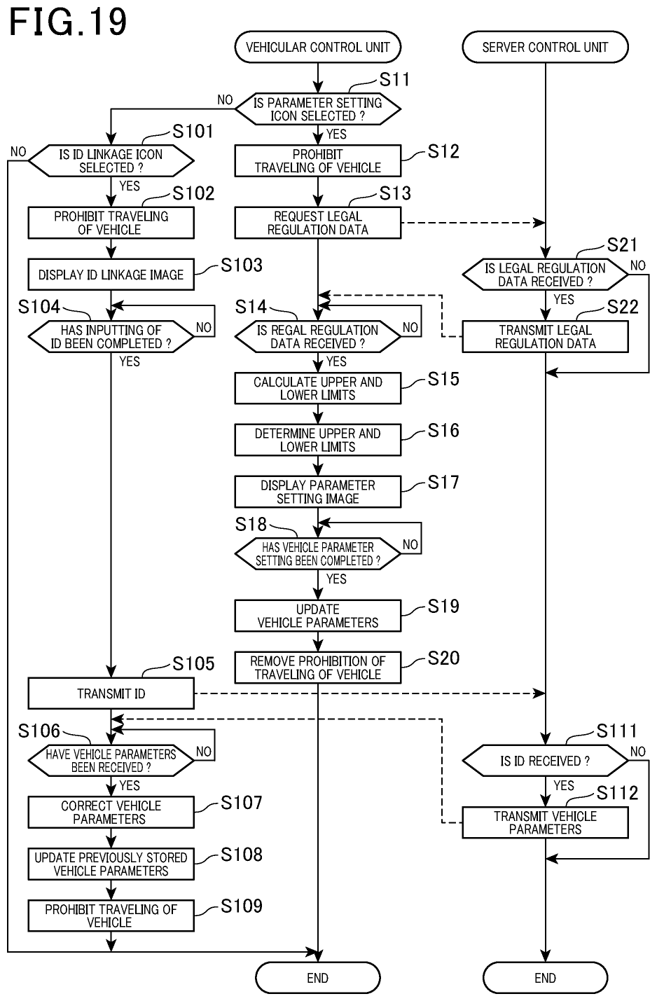

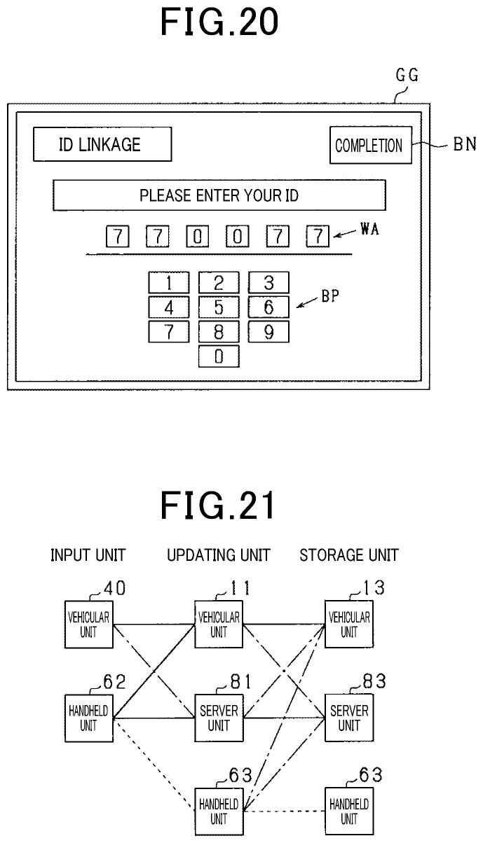

The following describes the fifth embodiment with reference to FIGS. 19 and 20. In particular, the following describes mainly different points of the fifth embodiment as compared with the first embodiment.

Specifically, plural sets of driver's selected vehicle parameters, which correlate with respective driver's IDs, are stored in the server storage unit 83 of the server apparatus 80. That is, a driver's input of the driver's ID to the vehicular control unit 11 in the setting routine of the fifth embodiment enables the corresponding set of the driver's selected vehicle parameters correlating with the inputted driver's ID to be inputted to the vehicular control unit 11. The driver's ID according to the fifth embodiment correspond to parameter information.

FIG. 19 illustrates a flowchart of the setting routine according to the fifth embodiment. Description of operations in the setting routine illustrated in FIG. 19, which are respectively identical to operations in the setting routine illustrated in FIG. 2, is omitted while identical step numbers are assigned to respective identical operations between the setting routines illustrated in respective FIGS. 2 and 19.

First, the following describes the first part of the setting routine carried out by the vehicular control unit 11.

When determining that the parameter setting icon BE has not been selected by a driver through the input unit 42, the vehicular control unit 11 determines that the vehicle-parameter setting request is not inputted thereto through the input unit 42 (NO in step S11), the setting routine proceeding to step S101.

In step S101, the vehicular control unit 11 determines whether an ID-used vehicle-parameter setting request is inputted thereto through the input unit 42.

Specifically, upon determination that the setting image GA is displayed on the display unit 41 while the vehicle MV is stopped, and the ID linkage icon BD is selected by a driver through the input unit 42, the vehicular control unit 11 determines that the ID-used vehicle-parameter setting request is inputted thereto through the input unit 42 (YES in step S101). Then, the setting routine proceeds to step S102. Otherwise, when determining that the ID linkage icon BD has not been selected by a driver through the input unit 42, the vehicular control unit 11 determines that the ID-used vehicle-parameter setting request is not inputted thereto through the input unit 42 (NO in step S101), terminating the setting routine.

In step S102, the vehicular control unit 11 performs a prohibition task of prohibiting traveling of the vehicle MV. Next, the vehicular control unit 11 permits a driver to input a driver's ID in step S103, the setting routine proceeding to step S104. Specifically, in step S104, the vehicular control unit 11 displays an ID linkage image GG on the display unit 41. The ID linkage image GG enables a driver to input a driver's ID thereon.

FIG. 20 illustrates the ID linkage image GG. The ID linkage image GG includes an ID input icon BQ for inputting an ID, an ID displaying field WA for displaying the inputted ID, and the completion icon BN.

The vehicular control unit 11 performs a task (see step S104) of waiting until inputting of a driver's ID has been completed (NO in step S104). Specifically, the vehicular control unit 11 waits until the completion icon BN of the ID linkage image GG has been selectively clicked.

When determining that inputting of a driver's ID has been completed (YES in step S104), the vehicular control unit 11 acquires the inputted driver's ID in step S104, and the setting routine proceeds to step S105.

Next, the vehicular control unit 11 serves as a communication unit to transmit, to the server apparatus 80, the driver's ID in step S105. Then, the vehicular control unit 11 serves as the communication unit to perform a determination task (see step S106) of waiting until receiving the set of the driver's selected vehicle parameters, which correlates with the driver's ID, from the server apparatus 80 (NO in step S106).

Upon receiving the set of the driver's selected vehicle parameters from the server apparatus 80, the determination task in step S106 is YES. Then, the vehicular control unit 11 serves as a correction unit to correct the driver's selected vehicle parameters of the received set in step S107. Specifically, because the vehicle parameters vary by vehicle, such as by vehicle's weight, the vehicular control unit 11 corrects the driver's selected vehicle parameters of the received set based on the weight of the vehicle MV that the driver selects to drive in step S107.

Following the operation in step S107, the vehicular control unit 11 serves as the updating unit that changes the present vehicle parameters stored in the vehicular storage unit 13 to the respective corrected vehicle parameters in step S108. Then, the vehicular control unit 11 stops, in step S109, the prohibition task to accordingly remove the prohibition of traveling of the vehicle MV, and thereafter terminates the setting routine.

Next, the following describes advantageous benefits achieved by the fifth embodiment.

If a driver wants to set driver's selected vehicle parameters, only inputting of a driver's ID to the vehicular control unit 11 enables the driver's selected vehicle parameters to be set, making it possible to eliminate the need of inputting, to the vehicular control unit 11 by a driver, the driver's ID. This therefore eliminates, from a driver, the need of inputting, to the vehicular control unit 11, the driver's ID, making it possible to reduce a driver's workload required to input the vehicle parameters to the vehicular control unit 11.

The plural sets of vehicle parameters, which correlate with respective driver's IDs, are stored in the server storage unit 83 of the server apparatus 80 according to the fifth embodiment. Because the vehicle parameters vary by vehicle's type, such as vehicle's weight, the vehicle parameters received from the server apparatus 80 may be unsuitable to a vehicle MV that a driver selects to drive.

From this viewpoint, the vehicular control unit 11 of the fifth embodiment is configured to correct the vehicle parameters received from the server apparatus 80 in accordance with the weight of a vehicle MV that a driver selects to drive.

This configuration of the vehicular control unit 11 therefore results in an improvement of the drivability of the vehicle MV based on the calculated vehicle parameters while reducing a driver's workload required to input the vehicle parameters to the vehicular control unit 11.

The present disclosure is not limited to the above embodiments, and can be implemented as follows.

Each vehicle MV is not limited to a vehicle that includes only a rotary electric machine as its power source, and can be a vehicle that includes only an internal combustion engine, or a vehicle that is equipped with both an internal combustion engine and a rotary electric machine.

As the user interface 40, the touch-panel display, which include various icons, of a vehicle navigation system or a hand-held terminal can be used as described above, but steering switches installed in each vehicle MV can be used as the user interface 40 for the corresponding vehicle MV.

The vehicular control unit 11 of the vehicular device 10 or the server control unit 81 of the server apparatus 80 can each serve as the updating unit for updating the vehicle parameters to new ones. The terminal control unit 63 of the handheld terminal 60 can also serve as the updating unit for updating the vehicle parameters to new ones.

A storage unit that stores the vehicle parameters is not limited to the vehicular storage unit 13 of the vehicular control unit 11 or the server storage unit 83 of the server apparatus 80. Specifically, a non-volatile memory, except for the ROM, installed in the terminal control unit 63 can serve as the storage unit that stores the vehicle parameters.

The first embodiment has described the combination of the user interface 40, the vehicular control unit 11, and the vehicular storage unit 13 (see solid line in FIG. 21) as the combination of the input interface, the updating unit, and the storage unit. The first modification of the first embodiment has described the combination of the input unit 62 of the handheld terminal 60, the vehicular control unit 11, and the vehicular storage unit 13 as the combination of the input interface, the updating unit, and the storage unit. The second modification of the first embodiment has described the combination of the input unit 62 of the handheld terminal 60, the server control unit 81, and the server storage unit 83 as the combination of the input interface, the updating unit, and the storage unit.

The combination of the input interface, the updating unit, and the storage unit according to the present disclosure is not limited to the above combinations. For example, as shown by dashed line in FIG. 21, the combination of the input unit 62 of the handheld terminal 60, the terminal control unit 63, and a non-volatile memory, except for a ROM, installed in the terminal control unit 63 can serve as the combination of the input interface, the updating unit, and the storage unit.

The combination of the input interface and the updating unit according to the present disclosure is not limited to the combinations described in the above embodiments.

Specifically, the server control unit 81 can be configured to receive vehicle parameters inputted by a driver through the user interface 40 of the vehicular device 10 (see dashed-dotted line in FIG. 21). The vehicle parameters stored in the server storage unit 83 can be updated by the vehicular control unit 11, or can be updated by the server control unit 81. The vehicle parameters stored in the vehicular storage unit 13 or the server storage unit 83 can be updated by the terminal control unit 63.

The updating unit according to the present disclosure can have (I) a function of updating the mobility parameters in accordance with a user's input, or (II) a first function of updating the mobility parameters in accordance with a user's input and a second function of updating the mobility parameters in accordance with the determination information, or (III) only a function of updating the mobility parameters in accordance with the determination information.

The feedback information is not limited to driver's inputted information, and can include driver's operation characteristics determined based on analysis of the traveling data of the driver.

Each of the first to fifth embodiments uses, as mobility devices, vehicles MV, but the present disclosure can use, as mobility devices, vessels or aerial vehicles. When the present disclosure uses vessels as the vehicles MV, the rotary electric machine 31B installed in each vessel serves as a power source for causing the vessel to travel. When the present disclosure uses aerial vehicles as the vehicles MV, the rotary electric machine 31B installed in each aerial vehicle serves as a power source for causing the aerial vehicle to fly.

The control apparatuses and control methods described in the present disclosure can be implemented by a dedicated computer including a memory and a processor programmed to perform one or more functions embodied by one or more computer programs.

The control apparatuses and control methods described in the present disclosure can also be implemented by a dedicated computer including a processor comprised of one or more dedicated hardware logic circuits.

The control apparatuses and control methods described in the present disclosure can further be implemented by a processor system comprised of a memory, a processor programmed to perform one or more functions embodied by one or more computer programs, and one or more hardware logic circuits.

The one or more programs can be stored in a non-transitory storage medium as instructions to be carried out by a computer or a processor.

While the illustrative embodiments of the present disclosure have been described herein, the present disclosure is not limited to the embodiments and their configurations described herein. Specifically, the present disclosure includes various modifications and/or alternatives within the scope of the present disclosure. In addition to various combinations and forms, other combinations and forms including one or more/less elements thereof are also within the inventive principle and scope of the present disclosure.

What is claimed is:

1. A control apparatus applicable to a drive system that measures a user's manipulated parameter, and drives, through a driving unit, a mobility device in accordance with a driving quantity determined based on the user's manipulated parameter, the user's manipulated parameter including at least one of a user's manipulated variable and a user's manipulated setting, the control apparatus comprising:
a storage unit that stores at least one mobility parameter that enables the driving quantity to be determined based on the user's manipulated parameter;
a parameter acquiring unit configured to acquire parameter information inputted by a user, the parameter information including at least one of (i) a user's selected at least one mobility parameter and (ii) information related to the user's selected at least one mobility parameter; and
an updating unit configured to update, based on the parameter information, the at least one mobility parameter stored in the storage unit.

2. The control apparatus according to claim 1, further comprising:
a determination information acquiring unit configured to acquire determination information that includes at least one of:
behavior information representing a behavior of the mobility device while the mobility device is moving;
environmental information representing environments around the mobility device; and
operation information on each structural unit that constitutes the mobility device, wherein:
the updating unit is configured to update, based on the determination information, the at least one mobility parameter stored in the storage unit when determining that the parameter acquiring unit has not acquired the parameter information.

3. A control apparatus applicable to a drive system that measures a user's manipulated parameter, and drives, through a driving unit, a mobility device in accordance with a driving quantity determined based on the user's manipulated parameter, the user's manipulated parameter including at least one of a user's manipulated variable and a user's manipulated setting, the control apparatus comprising:
a storage unit that stores at least one mobility parameter that enables the driving quantity to be determined based on the user's manipulated parameter;
a determination information acquiring unit configured to acquire determination information that includes at least one of:
behavior information representing a behavior of the mobility device while the mobility device is moving;
environmental information representing environments around the mobility device; and
operation information on each structural unit that constitutes the mobility device; and
an updating unit configured to update, based on the determination information, the at least one mobility parameter stored in the storage unit.

4. The control apparatus according to claim 1, wherein:
the mobility device is a vehicle including at least one driving wheel;
the user's manipulated parameter includes an accelerator opening indicative of a user's manipulated amount of an accelerator;
the driving unit includes a power generator that includes at least one of a rotary electric machine and an internal combustion engine;
the driving unit is configured to generate, as the driving quantity, driving torque based on the accelerator opening, and apply the generated driving torque to the at least one driving wheel of the vehicle; and
the at least one mobility parameter includes an accelerator parameter correlating with the accelerator opening and the driving torque.

5. The control apparatus according to claim 1, wherein:
the mobility device is a vehicle including at least one wheel;
the user's manipulated parameter includes a brake stroke indicative of a user's operated stroke of a brake member;
the driving unit includes a brake apparatus, and is configured to generate, as the driving quantity, braking torque based on the brake stroke, and apply the generated braking torque to the at least one wheel of the vehicle; and
the at least one mobility parameter includes a brake parameter correlating with the brake stroke and the braking torque.

6. The control apparatus according to claim 1, wherein:
the mobility device is a vehicle including at least one wheel;
the user's manipulated parameter includes a steering parameter that includes at least one of a user's steering angle of a steering wheel, and user's steering torque of the steering wheel;
the driving unit includes a power steering apparatus, and is configured to generate, as the driving quantity, assist torque as a function of the user's steering angle and the user's steering torque; and
the at least one mobility parameter includes a handling parameter correlating with the steering parameter and the assist torque.

7. The control apparatus according to claim 1, wherein:
the driving unit includes an air-conditioning apparatus that includes a blower for outputting air into an interior of the mobility device;
the user's manipulated parameter includes a user's manipulated setting of an air volume outputted from the blower;
the driving quantity is a rotational speed of the blower; and
the at least one mobility parameter includes an air-conditioning parameter correlating with the manipulated setting of the air volume and the rotational speed of the blower.

8. The control apparatus according to claim 1, wherein:
the driving unit includes an air-conditioning apparatus that includes a heater;
the user's manipulated parameter includes a user's manipulated setting of a temperature of the heater;
the driving quantity is an electric current supplied to flow through the heater; and
the at least one mobility parameter includes an air-conditioning parameter correlating with the manipulated setting of the temperature of the heater and the electric current.

9. The control apparatus according to claim 1, wherein:
the mobility device includes:
a battery chargeable by an external battery charger;
an inverter electrically connected to the battery; and
a rotational electric machine electrically connected to the inverter, the rotational electric machine serving as a power source for causing the mobility device to move;
the user's manipulated parameter includes the user's manipulated setting of a charging variable that includes at least one of a charging voltage and a charging current for the battery; and
the at least one mobility parameter includes a charging parameter correlating with a charging period from the battery charger to the battery and the charging variable.

10. The control apparatus according to claim 3, wherein:
the mobility device is a vehicle including at least one driving wheel;
the user's manipulated parameter includes an accelerator opening indicative of a user's manipulated amount of an accelerator;
the driving unit includes a power generator that includes at least one of a rotary electric machine and an internal combustion engine;
the driving unit is configured to generate, as the driving quantity, driving torque based on the accelerator opening, and apply the generated driving torque to the at least one driving wheel of the vehicle;
the at least one mobility parameter includes an accelerator parameter correlating with the accelerator opening and the driving torque;
the behavior information includes time-series information on the accelerator opening; and
the updating unit is configured to update, based on the time-series information, the at least one mobility parameter stored in the storage unit.

11. The control apparatus according to claim 3, wherein:
the mobility device is a vehicle including at least one wheel;
the user's manipulated parameter includes a brake stroke indicative of a user's operated stroke of a brake member;
the driving unit includes a brake apparatus, and is configured to generate, as the driving quantity, braking torque based on the brake stroke, and apply the generated braking torque to the at least one wheel of the vehicle;
the at least one mobility parameter includes a brake parameter correlating with the brake stroke and the braking torque;
the behavior information includes time-series information on the brake stroke; and
the updating unit is configured to update, based on the time-series information, the at least one mobility parameter stored in the storage unit.

12. The control apparatus according to claim 1, further comprising:
an efficiency information acquiring unit configured to acquire, as efficiency information, information on an energy efficiency of the mobility device, wherein:
the updating unit is configured to update, based on the parameter information and the efficiency information, the at least one mobility parameter stored in the storage unit.

13. The control apparatus according to claim 1, further comprising:
a changing unit configured to change a value of the at least one mobility parameter to plural test values independently of the user's input of the user's selected at least one mobility parameter; and
a feedback information acquiring unit configured to acquire feedback information on a behavior of the mobility device that is moving based on the plural test values of the at least one mobility parameter, wherein:
the updating unit is configured to update, based on the feedback information, the at least one mobility parameter stored in the storage unit.

14. The control apparatus according to claim 1, wherein the parameter information includes the user's selected at least one mobility parameter, the control apparatus further comprising:
an upper and lower limit determiner configured to determine an upper limit and a lower limit for the at least one mobility parameter; and
a permission unit configured to permit a user to input the parameter information within an input range defined between the upper limit and the lower limit inclusive.

15. The control apparatus according to claim 14, wherein the drive system includes an external storage unit located outside the mobility device, the external storage unit storing upper-lower limit determination information used to determine the upper and lower limits for the at least one mobility parameter, the control apparatus further comprising:
a communication unit configured to receive the upper-lower limit determination information from the external storage unit,
the upper and lower limit determiner being configured to determine, based on the upper-lower limit determination information, the upper limit and the lower limit for the at least one mobility parameter.

16. The control apparatus according to claim 1, wherein:
the parameter information includes, as the information related to the user's selected at least one mobility parameter, identification information on a user;
the drive system includes an external storage unit located outside the mobility device, the external storage unit storing the identification information and the user's selected at least one mobility parameter correlating with one another, the control apparatus further comprising:
a communication unit configured to:
transmit, to the external storage unit, the identification information; and
receive, from the external storage unit, the user's selected at least one mobility parameter correlating with the identification information,
the updating unit is configured to update, based on the user's selected at least one mobility parameter received from the external storage unit, the at least one mobility parameter stored in the storage unit.

17. The control apparatus according to claim 16, further comprising:
a correction unit configured to correct the user's selected at least one mobility parameter received from the external storage unit based on a weight of the mobility device, wherein:
the updating unit is configured to update, based on the corrected user's selected at least one mobility parameter, the at least one mobility parameter stored in the storage unit.

18. A drive system for a mobility device, the drive system comprising:
a measuring unit configured to measure a user's manipulated parameter that includes at least one of a user's manipulated variable and a user's manipulated setting;
a driving unit configured to drive the mobility device in accordance with a driving quantity determined based on the user's manipulated parameter; and
a control apparatus that comprises:
a storage unit that stores at least one mobility parameter that enables the driving quantity to be determined based on the user's manipulated parameter;
a parameter acquiring unit configured to acquire parameter information inputted by a user, the parameter information including at least one of (i) a user's selected at least one mobility parameter and (ii) information related to the user's selected at least one mobility parameter; and
an updating unit configured to update, based on the parameter information, the at least one mobility parameter stored in the storage unit.

19. A program product applicable to a drive system that includes:
a measuring unit configured to measure a user's manipulated parameter that includes at least one of a user's manipulated variable and a user's manipulated setting;
a driving unit configured to drive the mobility device in accordance with a driving quantity determined based on the user's manipulated parameter; and
a control apparatus that includes a storage unit that stores at least one mobility parameter that enables the driving quantity to be determined based on the user's manipulated parameter, the program product causing the control apparatus to:
acquire parameter information inputted by a user, the parameter information including at least one of (i) a user's selected at least one mobility parameter and (ii) information related to the user's selected at least one mobility parameter; and
update, based on the parameter information, the at least one mobility parameter stored in the storage unit.
